(19) United States
(12) Patent Application Publication
(10) Pub. No.: US 2026/0031061 A1
(43) Pub. Date: Jan. 29, 2026

(54) METHODS AND SYSTEMS USING BARYCENTRIC COORDINATES FOR COLOR ENHANCEMENT IN IMAGES RENDERED ON ELECTROPHORETIC DISPLAYS

(71) Applicant: E INK CORPORATION, Billerica, MA (US)

(72) Inventors: Brian GAMM, North Billerica, MA (US); Kenneth R. CROUNSE, Somerville, MA (US)

(21) Appl. No.: 19/268,212

(22) Filed: Jul. 14, 2025

Related U.S. Application Data
(60) Provisional application No. 63/674,474, filed on Jul. 23, 2024.

(51) Int. Cl. G09G 3/38

(52) U.S. Cl. CPC G09G 3/38; G09G 2320/0285; G09G 2320/0666; G09G 2340/06

(57) ABSTRACT

Methods and systems are provided for enhancing colors in images rendered on electrophoretic displays using Barycentric coordinates. The enhancement is performed within the workflow for mapping device-dependent pixel values of source images to device-dependent pixel values of destination images. The input and output color spaces each contain a plurality of palette primary (PP) colors, nominally eight. The color spaces are divided into a plurality of tetrahedra defined by four adjacent PPs. The PPs in the input color space and output color space are associated with each other by having the same respective hues. Pixel values of the source image are located in one of the six tetrahedra and are converted to Barycentric coordinates. The Barycentric coordinates are modified using lightness and/or chroma enhancement to improve the appearance of the final gamut mapped image in the output color space.

### CROSS REFERENCE TO RELATED APPLICATION(S)

This application claims priority from U.S. Provisional Patent Application No. 63/674,474 filed on Jul. 23, 2024 entitled METHODS AND SYSTEMS USING BARYCENTRIC COORDINATES FOR COLOR ENHANCEMENT IN IMAGES RENDERED ON ELECTROPHORETIC DISPLAYS, which is hereby incorporated by reference in its entirety.

### BACKGROUND

The present application relates generally to electrophoretic displays and, more particularly, to methods of enhancing colors in images rendered on such displays.

Electrophoretic displays change color by modifying the position of a charged colored particle with respect to a light-transmissive viewing surface. Such electrophoretic displays are typically referred to as “electronic paper” or “ePaper” because the resulting display has high contrast and is sunlight-readable, much like ink on paper. Electrophoretic displays have enjoyed widespread adoption in eReaders, such as the AMAZON KINDLE® because the electrophoretic displays provide a book-like reading experience, use little power, and allow a user to carry a library of hundreds of books in a lightweight handheld device.

For many years, electrophoretic displays included only two types of charged color particles, black and white. (To be sure, “color” as used herein includes black and white.) The white particles are often of the light scattering type, and comprise, e.g., titanium dioxide, while the black particle are absorptive across the visible spectrum, and may comprise carbon black, or an absorptive metal oxide, such as copper chromite. In the simplest sense, a black and white electrophoretic display only requires a light-transmissive electrode at the viewing surface, a back electrode, and an electrophoretic medium including oppositely charged white and black particles. When a voltage of one polarity is provided, the white particles move to the viewing surface, and when a voltage of the opposite polarity is provided the black particles move to the viewing surface. If the back electrode includes controllable regions (pixels)—either segmented electrodes or an active matrix of pixel electrodes controlled by transistors—a pattern can be made to appear electronically at the viewing surface. The pattern can be, e.g., the text to a book.

More recently, a variety of color option have become commercially available for electrophoretic displays, including three-color displays (black, white, red; black white, yellow), and four color displays (black, white, red, yellow). Similar to the operation of black and white electrophoretic displays, electrophoretic displays with three or four reflective pigments operate similar to the simple black and white displays because the desired color particle is driven to the viewing surface. The driving schemes are far more complicated than only black and white, but in the end, the optical function of the particles is the same.

Advanced Color electronic Paper (ACeP®) also includes four particles, but the cyan, yellow, and magenta particles are subtractive rather than reflective, thereby allowing thousands of colors to be produced at each pixel. The color process is functionally equivalent to the printing methods that have long been used in offset printing and ink-jet printers. A given color is produced by using the correct ratio of cyan, yellow, and magenta on a bright white paper background. In the instance of ACeP®, the relative positions of the cyan, yellow, magenta and white particles with respect to the viewing surface will determine the color at each pixel. While this type of electrophoretic display allows thousands of colors at each pixel, it is critical to carefully control the position of each of the (50 to 500 nanometer-sized) pigments within a working space of about 10 to 20 micrometers in thickness. Obviously, variations in the position of the pigments will result in incorrect colors being displayed at a given pixel. Accordingly, exquisite voltage control is required for such a system. More details of this system are available in the following U.S. patents, all of which are incorporated by reference in their entireties: U.S. Pat. Nos. 9,361,836; 9,921,451; 10,276,109; 10,353,266; 10,467,984; and 10,593,272.

This invention relates to color electrophoretic displays capable of rendering more than two colors using a single layer of electrophoretic material comprising a plurality of colored particles, e.g., white, cyan, yellow, and magenta particles. In some instances, two of the particles will be positively-charged, and two particles will be negatively-charged. In some instances, three of the particles will be positively-charged, and one particle will be negatively-charged. In some instances, one positively-charged particle has a thick polymer shell, and one negatively-charged particle has a thick polymer shell.

The term gray state is used herein in its conventional meaning in the imaging art to refer to a state intermediate two extreme optical states of a pixel and does not necessarily imply a black-white transition between these two extreme states. For example, several of the E Ink patents and published applications referred to below describe electrophoretic displays in which the extreme states are white and deep blue, so that an intermediate gray state would actually be pale blue. Indeed, as already mentioned, the change in optical state may not be a color change at all. The terms black and white may be used hereinafter to refer to the two extreme optical states of a display, and should be understood as normally including extreme optical states which are not strictly black and white, e.g., the aforementioned white and dark blue states.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays.

The term impulse, when used to refer to driving an electrophoretic display, is used herein to refer to the integral of the applied voltage with respect to time during the period in which the display is driven.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Particle-based electrophoretic displays have been the subject of intense research and development for several years. In such displays, a plurality of charged particles (sometimes referred to as pigment particles) move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, e.g., Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, e.g., in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation, E Ink California, LLC, and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see, e.g., U.S. Pat. No. 7,002,728;
(b) Capsules, binders and encapsulation processes; see, e.g., U.S. Pat. Nos. 6,922,276 and 7,411,719;
(c) Microcell structures, wall materials, and methods of forming microcells; see, e.g., U.S. Pat. Nos. 7,072,095 and 9,279,906;
(d) Methods for filling and sealing microcells; see, e.g., U.S. Pat. No. 7,715,088 and U.S. Patent Application Publication No. 2002/0188053;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation and color adjustment; see, e.g., U.S. Pat. Nos. 7,075,502 and 7,839,564;
(h) Methods for driving displays; see, e.g., U.S. Pat. Nos. 7,012,600 and 7,453,445;
(i) Applications of displays; see, e.g., U.S. Pat. Nos. 7,312,784 and 8,009,348; and
(j) Non-electrophoretic displays, as described in U.S. Pat. No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. Sec, e.g., U.S. Pat. Nos. 6,672,921 and 6,788,449.

Although electrophoretic media are often opaque (since, e.g., in many electrophoretic media, the particles substantially block transmission of visible light through the display) and operate in a reflective mode, many electrophoretic displays can be made to operate in a so-called shutter mode in which one display state is substantially opaque and one is light-transmissive. Sec, e.g., U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

A commonly used system for quantifying the color characteristics of a display, including both brightness and hue is the CIELAB system, which assigns color coordinate values (i.e., L*, a*, b*) corresponding to colors displayed by typical color reflective display devices under a CIE standard illuminant D65 (e.g., with color temperature 6500K). L* represents lightness from black to white on a scale of zero to 100, while a* and b* represent chromaticity with no specific numeric limits. Negative a* corresponds with green, positive a* corresponds with red, negative b* corresponds with blue and positive b* corresponds with yellow. L* can be converted to reflectance with the following formula: L*=116(R/R₀)^{1/3}−16, where R is the reflectance and R₀ is a standard reflectance value.

U.S. Pat. Nos. 8,576,476 and 8,797,634 describe multicolor electrophoretic displays having a single back plane comprising independently addressable pixel electrodes and a common, light-transmissive front electrode. The common, light-transmissive front electrode is also known as the top electrode. A plurality of electrophoretic layers are disposed between the back plane and the front electrode. Displays described in these applications are capable of rendering any of the primary colors (red, green, blue, cyan, magenta, yellow, white and black) at any pixel location. However, there are disadvantages to the use of multiple electrophoretic layers located between a single set of addressing electrodes. The electric field experienced by the particles in a particular layer is lower than would be the case for a single electrophoretic layer addressed with the same voltage. In addition, optical losses in an electrophoretic layer closest to the viewing surface (e.g., caused by light scattering or unwanted absorption) may affect the appearance of images formed in underlying electrophoretic layers.

Attempts have been made to provide full-color electrophoretic displays using a single electrophoretic layer. For example, U.S. Pat. No. 8,917,439 describes a color display comprising an electrophoretic fluid that comprises one or two types of pigment particles dispersed in a clear and colorless or colored solvent, the electrophoretic fluid being disposed between a common electrode and a plurality of pixel or driving electrodes. The driving electrodes are arranged to expose a background layer. U.S. Pat. No. 9,116,412 describes a method for driving a display cell filled with an electrophoretic fluid comprising two types of charged particles carrying opposite charge polarities and of two contrast colors. The two types of pigment particles are dispersed in a colored solvent or in a solvent with non-charged or slightly charged colored particles dispersed therein. The method comprises driving the display cell to display the color of the solvent or the color of the non-charged or slightly charged colored particles by applying a driving voltage that is about 1 to about 20% of the full driving voltage. U.S. Pat. Nos. 8,717,664 and 8,964,282 describe an electrophoretic fluid, and a method for driving an electrophoretic display. The fluid comprises first, second and third type of pigment particles, all of which are dispersed in a solvent or solvent mixture. The first and second types of pigment particles carry opposite charge polarities, and the third type of pigment particles has a charge level being less than about 50% of the charge level of the first or second type. The three types of pigment particles have different levels of threshold voltage, or different levels of mobility, or both. None of these patent applications disclose full color display in the sense in which that term is used below, that is capable of achieving at least eight independent colors (white, red, green, blue, cyan, yellow, magenta, and black). As has been described previously, the gamut (color space) that results from electrophoretic display systems, such as Advanced Color electronic Paper can be variable depending upon environmental conditions and the chosen driving waveforms. See, e.g., U.S. Pat. No. 10,467,984, which is incorporated by reference in its entirety.

The bulk of electronic color images in the world are formatted in a red-green-blue (RGB) color space, corresponding to the red, green, and blue subpixels that are commonly used in liquid crystal displays (LCD), light emitting diode (LED) displays, or cathode ray tube (CRT) displays. A common format is an 8-bit RGB that assigns red, green, and blue subpixel values to each pixel in the image as a set of three numbers, each number spanning from 0-255. Accordingly, a standard RGB (sRGB) image file consists of a set of numbers corresponding to pixels in the image. When those color levels are provided to the assigned pixels, the image appears on the display. The next image file, corresponding to a new photograph or a next frame of a video, has a new set of numbers at each pixel.

The RGB numbers do not map directly into the color space used with electrophoretic displays. Thus, it is necessary to transform the RGB image files to a new format. Additionally, because the shape of the RGB gamut is quite different from the shape of, e.g., an ACeP® gamut, there is no simple transform that will convert an RGB file to an ACcP® file.

### SUMMARY

A computer-implemented method in accordance with a first aspect of the invention comprises: (a) dividing a three-dimensional red-green-blue (RGB) input color space defined by a plurality of primary palette points, including a black primary palette point, a white primary palette point, and other primary palette points, into a plurality of adjacent, non-overlapping tetrahedra, each tetrahedron of the plurality of tetrahedra defined by the black primary palette point, the white primary palette point, and two of the other primary palette points; (b) mapping sampled colors of the RGB input color space to grid points in an N×N×N grid; (c) for each of the grid points, identifying a tetrahedron of the plurality of tetrahedra in which the grid point is located and calculating Barycentric coordinates of the grid point in the tetrahedron; (d) performing lightness enhancement and/or chroma enhancement of the colors of the RGB input color space mapped to the grid points thereby modifying the Barycentric coordinates of the grid points for each color; (e) calculating Cartesian coordinates of points in an RGB output color space defined by a plurality of output primary palette points for each of the colors enhanced in step (d) and mapped to the grid points having modified Barycentric coordinates; and (f) populating a color lookup table (CLUT) with the grid points of the RGB input color space and corresponding Cartesian coordinates of the RGB output color space to be utilized for converting source images from the RGB input color space to the RGB output color space.

A computer-implemented method in accordance with a second aspect of the invention comprises: (a) converting coordinates of primary palette points defining a three-dimensional device-dependent red-green-blue (RGB) input color space to coordinates of a three-dimensional device-independent color space, wherein the primary palette points comprise a black primary palette point, a white primary palette point, and other primary palette points; (b) dividing the three-dimensional RGB input color space defined by the primary palette points having coordinates converted in step (a) into a plurality of adjacent, non-overlapping tetrahedra, each tetrahedron of the plurality of tetrahedra defined by the black primary palette point, the white primary palette point, and two of the other primary palette points; (c) mapping sampled colors of the three-dimensional device-dependent RGB input color space to grid points in an N×N×N grid; (d) converting the grid points of the RGB input color space to corresponding values of the device-independent color space; (e) for each of the RGB input color space grid points converted in step (d), identifying a tetrahedron of the plurality of tetrahedra in which the grid point is located and calculating Barycentric coordinates of the grid point in the tetrahedron; (f) performing lightness enhancement and/or chroma enhancement of colors mapped to the grid points thereby modifying the Barycentric coordinates of the grid points for each color; (g) calculating Cartesian coordinates of points in an RGB device-independent output color space defined by a plurality of device-independent output primary palette points for each of the colors enhanced in step (f) and mapped to the grid points having modified Barycentric coordinates; (h) converting the points of the RGB device-independent output color space calculated in step (g) to the RGB input color space; (i) populating a color lookup table (CLUT) with the grid points of the RGB input color space and corresponding Cartesian coordinates of the RGB output color space to be utilized for converting source images from the RGB input color space to the RGB output color space.

A computer-implemented method in accordance with a third aspect of the invention comprises: (a) dividing a three-dimensional red-green-blue (RGB) input color space defined by a plurality of primary palette points, including a black primary palette point, a white primary palette point, and other primary palette points, into a plurality of adjacent, non-overlapping tetrahedra, each tetrahedron of the plurality of tetrahedra defined by the black primary palette point, the white primary palette point, and two of the other primary palette points; (b) mapping sampled colors of the RGB input color space to grid points in an N×N×N grid; (c) performing at least one of brightness enhancement, contrast enhancement, and saturation enhancement of the colors of the RGB input color space mapped to the grid points; (d) for each of the grid points, identifying a tetrahedron of the plurality of tetrahedra in which the grid point is located and calculating Barycentric coordinates of the grid point in the tetrahedron; (e) calculating Cartesian coordinates of points in an RGB output color space defined by a plurality of output primary palette points for each of the colors enhanced in step (c) and mapped to the grid points having the Barycentric coordinates; and (f) populating a color lookup table (CLUT) with the grid points of the RGB input color space and corresponding Cartesian coordinates of the RGB output color space to be utilized for converting source images in the RGB input color space to the RGB output color space.

In one or more embodiments, the source images comprise RGB image files.

In one or more embodiments, the source images comprise standard RGB (sRGB) image files.

In one or more embodiments, the RGB output color space comprises a color gamut of a color electrophoretic display.

In one or more embodiments, the RGB input color space is divided into a plurality of adjacent, non-overlapping tetrahedra using Kuhn decomposition.

In one or more embodiments, N=18.

In one or more embodiments, the plurality of primary palette points comprise the black primary palette point, the white primary palette point, a red primary palette point, a green primary palette point, a blue, primary palette point, a cyan primary palette point, a magenta primary palette point, and a yellow primary palette point.

In one or more embodiments, the RGB input color space comprises a cube having eight vertices, each corresponding to a different one of the plurality of primary palette points, and the RGB output color space comprises an asymmetric polyhedron having eight vertices, each corresponding to a different one of the plurality of output primary palette points.

In one or more embodiments, lightness enhancement is performed by reapportioning the Barycentric coordinates for white and black colors.

In one or more embodiments, chroma enhancement is performed by moving the Barycentric coordinates for colors other than black and white colors toward a gamut boundary, while preserving neutrality of neutral colors.

In one or more embodiments, the method further comprises converting a source image from the RGB input color space to the RGB output color space using the CLUT, and displaying the image in the RGB output color space on an electrophoretic display.

A color display in accordance with a further aspect of the invention, comprises an electrophoretic display comprising a light-transmissive electrode, an active matrix of pixel electrodes, and an electrophoretic medium comprising multiple types of electrophoretic particles having different optical properties. The electrophoretic medium is disposed between the light-transmissive electrode and the active matrix of pixel electrodes. The electrophoretic display is capable of producing a plurality of primary colors at each pixel electrode. The display further comprises at least one processor; at least one controller coupled to the at least one processor, and configured to provide electrophoretic display pixel color instructions to the active matrix of pixel electrodes; at least one non-transitory memory coupled to the at least one processor having the CLUT generated by any of the methods disclosed herein and a program containing a plurality of instructions which, when executed by the at least one processor, cause the at least one processor to (i) convert a source image from the RGB input color space to the RGB output color space using the CLUT, and (ii) instruct the at least one controller to cause the electrophoretic medium to display the image in the RGB output color space.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic cross-section showing an example of an encapsulated electrophoretic display suitable for use with the methods of the invention.

FIG. 2 is a schematic cross-section showing another example of an encapsulated electrophoretic display suitable for use with the methods of the invention.

FIG. 3A illustrates an exemplary equivalent circuit of a single pixel of an electrophoretic display wherein the voltage on the single pixel is controlled with a transistor. The circuit of FIG. 3A is commonly used in active-matrix backplanes.

FIG. 3B illustrates an exemplary color display that includes a display module, which can be any electro-optic display module, but is preferably a color electrophoretic display module. The color display also includes a processor, memory, one or more power supplies, and a controller.

FIG. 4 is a schematic cross-section showing the positions of the various colored particles in a colored electrophoretic medium when displaying black, white, three subtractive primary colors and three additive primary colors.

FIG. 5 shows exemplary push-pull drive schemes for addressing an electrophoretic medium including three subtractive particles and a scattering (white) particle.

FIG. 6 depicts an idealized transformation between a standard RGB color space and an idealized device color space wherein the two color spaces are similar in shape and size. In practice the standard RGB color space and an ACeP® color space are not similar in shape and size necessitating the use of tetrahedral decompositions, mapping, and reconstruction.

FIG. 7A shows a first step of deconstructing the RGB color space into a series of tetrahedra.

FIG. 7B shows a second step of mapping color data from a deconstructed RGB tetrahedron to a deconstructed device color space (i.e., ACeP® color space) tetrahedron.

FIG. 8 illustrates an exemplary process of dithering the mapped colors to produce an ACeP® image file for display on the device.

FIG. 9 is a flow chart illustrating an exemplary process for rendering an image on a display device.

FIG. 10 is a flow chart illustrating an exemplary RGB input color space (ICS) enhancement process in accordance with a first aspect of the invention.

FIG. 11 is a simplified illustration of an sRGB ICS gamut cube with black, white, red, green, blue, cyan, magenta, and yellow vertices.

FIG. 12 is a flow chart illustrating an exemplary Barycentric enhancement method in which Barycentric coordinates are derived from sRGB ICS values in accordance with a second aspect of the invention.

FIG. 13 is a flow chart illustrating an exemplary Barycentric enhancement method in which Barycentric coordinates are derived from one of a plurality of device-independent color values in accordance with a third aspect of the invention.

FIG. 14 is a simplified illustration of an sRGB ICS gamut cube divided into six tetrahedra using Kuhn decomposition. As shown, all tetrahedra include the white and black vertices.

FIG. 15 illustrates an sRGB output color space (OCS) gamut polyhedron represented within the space of the sRGB ICS gamut cube.

FIG. 16 illustrates a mapping between the sRGB ICS gamut cube and the OCS gamut polyhedron.

FIG. 17 shows two triangles representing an ICS and OCS with three colors: white, black, and C₁ (an arbitrary color).

FIG. 18 shows a point, Xi, mapped from its position in the ICS to its relative position in the OCS, Xo.

FIG. 19 illustrates the Barycentric coordinates of the points X_{I} and Xo, α_{W}, α_{K}, and α_{C,1} in the ICS and OCS.

FIG. 20 shows the point Xo in a tetrahedron consisting of white (Wo), black (Ko), chromatic color 1 (C_{o,1}), and chromatic color 2 (C_{o,2}) palette primary (PP) colors.

FIG. 21 illustrates the reduction in Barycentric dimensionality to two dimensions, α_{N} and α_{C}.

FIG. 22 illustrates lightness and chroma enhancements using a gamut triangle.

FIG. 23 shows graphs illustrating an example of white and black Barycentric coordinates before and after lightness enhancement with γ_{L}=0.7, γ_{L}=0.3, and σ_{L}=0.2.

FIG. 24 shows graphs illustrating an example of Barycentric coordinates before and after chroma enhancement with γ_{C}=0.8, γ_{C}=0.4, and σ_{C}=0.2. The top four plots are the four Barycentric coordinates, and the bottom two plots are ax and ac.

FIG. 25 shows renderings of a test image with no enhancement (upper left), lightness enhancement (upper right), chroma enhancement (lower left), and both lightness and chroma enhancements (lower right).

FIG. 26 shows renderings of a second test image with no enhancement (left), lightness enhancement (left center), chroma enhancement (right center), and both lightness and chroma enhancements (right).

### DETAILED DESCRIPTION

Various embodiments of the invention relate to enhancing colors of rendered images using Barycentric coordinates. The enhancement is performed within the workflow for mapping source (input) colors (typically standard RGB values) to device colors (e.g., ACeP® device colors) at each pixel of a color electrophoretic display. Such a display typically has a short list of possible colors that can be made, called a palette. In a typical situation among the palette colors there are typically eight colors chosen: Black (K), Red (R), Green (G), Blue (B), Cyan (C), Magenta (M), Yellow (Y), and White (W) although the actual colors will not be the same as the source space colors with those names. These colors can be dithered to provide the sensation of a continuous range of tones when viewed from sufficient distance. Depending upon the number of pixels of the device and the size of the respective pixels, a sufficient distance can be a few centimeters to a few meters (or more).

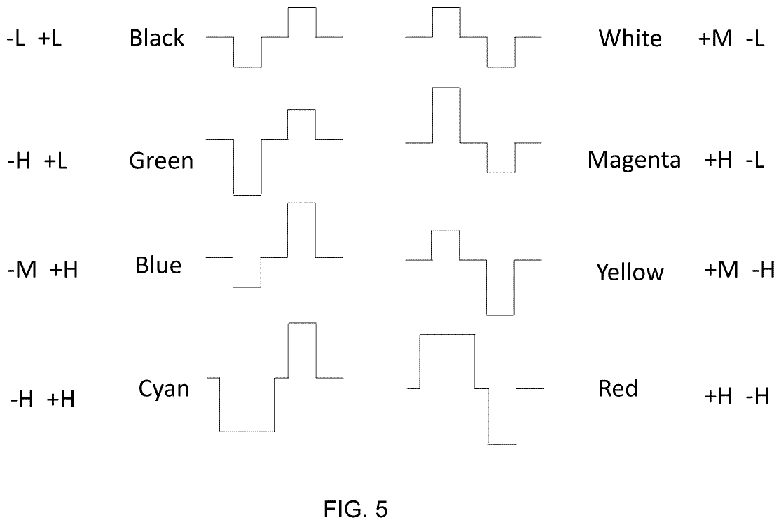

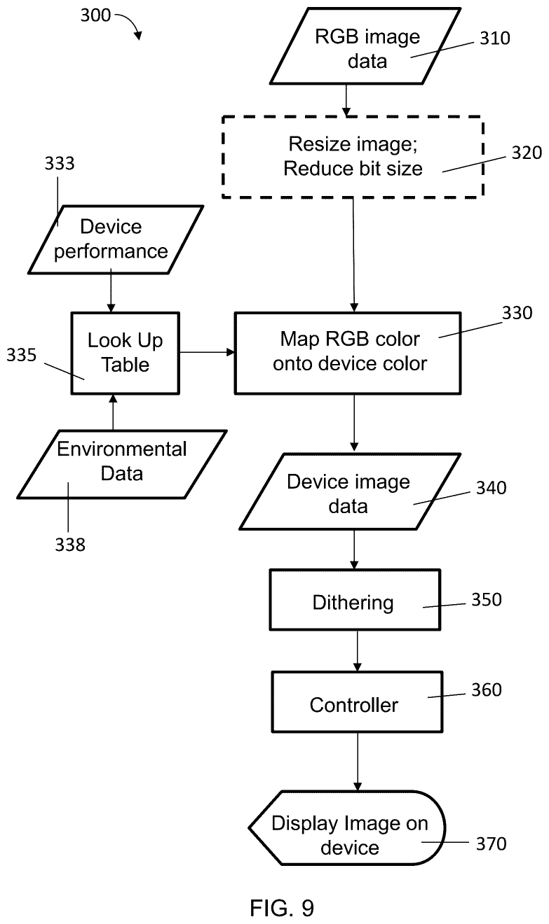

In the standard situation, the eight palette colors are associated with the basic colors: K, R, G, B, C, M, Y, W that are the corners of an R,G,B cube (see FIGS. 6 and 11). These colors are the most chromatic source space colors and are mapped to the palette colors directly. That is, if the pixel in source space is (R,G,B)=255,0,0 that pixel should be mapped to the palette color that is associated with Red, etc.

In some instances, the system includes electrophoretic media using a positive and a negative voltage source, where the voltage sources have different magnitudes, and a controller that cycles the top electrode between the two voltage sources and ground while coordinating driving at least two drive electrodes opposed to the top electrode. The resulting system can achieve roughly the same color states as compared to supplying each drive electrode with six independent drive levels and ground. Thus, the system simplifies the required electronics with only marginal loss in color gamut. The system is particularly useful for addressing an electrophoretic medium including four sets of different particles, e.g., wherein three of the particles are colored and subtractive and one of the particles is light-scattering.

A display device may be constructed using an electrophoretic fluid of the invention in several ways that are known in the prior art. The electrophoretic fluid may be encapsulated in microcapsules or incorporated into microcell structures that are thereafter sealed with a polymeric layer. The microcapsule or microcell layers may be coated or embossed onto a plastic substrate or film bearing a transparent coating of an electrically conductive material. This assembly may be laminated to a backplane bearing pixel electrodes using an electrically conductive adhesive. Alternatively, the electrophoretic fluid may be dispensed directly on a thin open-cell grid that has been arranged on a backplane including an active matrix of pixel electrodes. The filled grid can then be top-sealed with an integrated protective sheet/light-transmissive electrode.

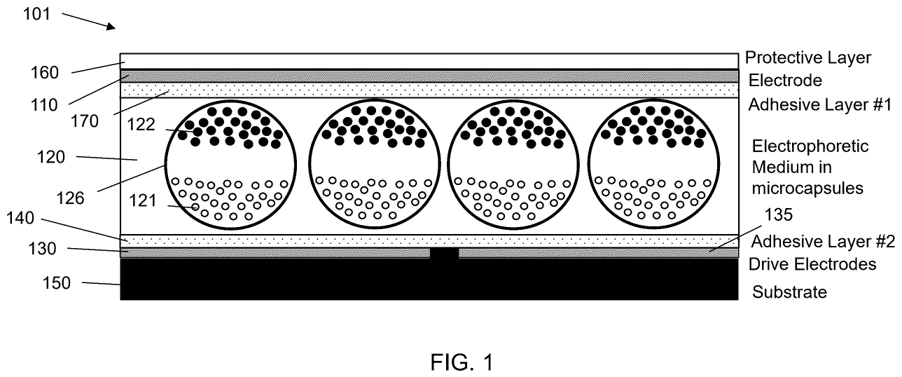

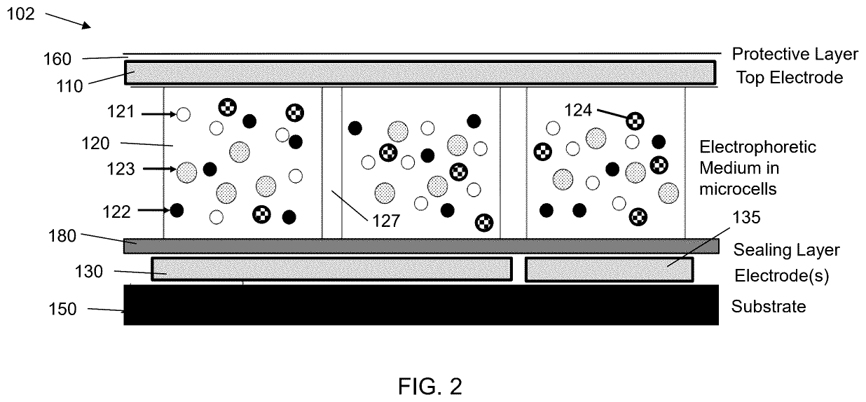

Regarding FIGS. 1 and 2, an electrophoretic display (101, 102) typically includes a top light-transmissive electrode 110, an electrophoretic medium 120, and bottom drive electrodes 130/135, which are often pixel electrodes of an active matrix of pixels controlled with thin film transistors (TFT). Alternatively, bottom drive electrodes 130/135 may be directly wired to a controller or some other switch that provides voltage to the bottom drive electrodes 130/135 to effect a change in the optical state of the electrophoretic medium 120, i.e., segmented electrodes. Importantly, it is not necessary that a junction between drive electrodes 130/135 corresponds with an intersection of microcapsules or with a wall 127 of a microcell. Because the electrophoretic medium 120 is sufficiently thin, and the capsules or microcells sufficiently wide, the pattern of the drive electrodes (square, circles, hexagons, wavy, text, or otherwise) will show when the display is viewed from the viewing surface; not the pattern of the containers. The electrophoretic medium 120 contains at least one electrophoretic particle 121, however a second electrophoretic particle 122, or a third electrophoretic particle 123, a fourth electrophoretic particle 124, or more particles is feasible. (It should be noted that third electrophoretic particles 123 and fourth electrophoretic particles 124 can be included within the microcapsules 126 of FIG. 1, but have been omitted for clarity.) The electrophoretic medium 120 typically includes a solvent, such as isoparaffins, and may also include dispersed polymers and charge control agents to facilitate state stability, e.g. bistability, i.e., the ability to maintain an electro-optic state without inputting any additional energy.

The electrophoretic medium 120 is typically compartmentalized by a microcapsule 126 or the walls of a microcell 127. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include one or more adhesive layers 140, 170, and/or sealing layers 180 as needed. In some embodiments an adhesive layer may include a primer component to improve adhesion to the electrode layer 110, or a separate primer layer (not shown in FIG. 1 or 2) may be used. (The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

Thin-film-transistor (TFT) backplanes usually have only one transistor per pixel electrode or propulsion electrode. Conventionally, each pixel electrode has associated therewith a capacitor electrode such that the pixel electrode and the capacitor electrode form a capacitor; see, e.g., International Patent Application WO 01/07961. In some embodiments, N-type semiconductor (e.g., amorphous silicon) may be used to from the transistors and the “select” and “non-select” voltages applied to the gate electrodes can be positive and negative, respectively.

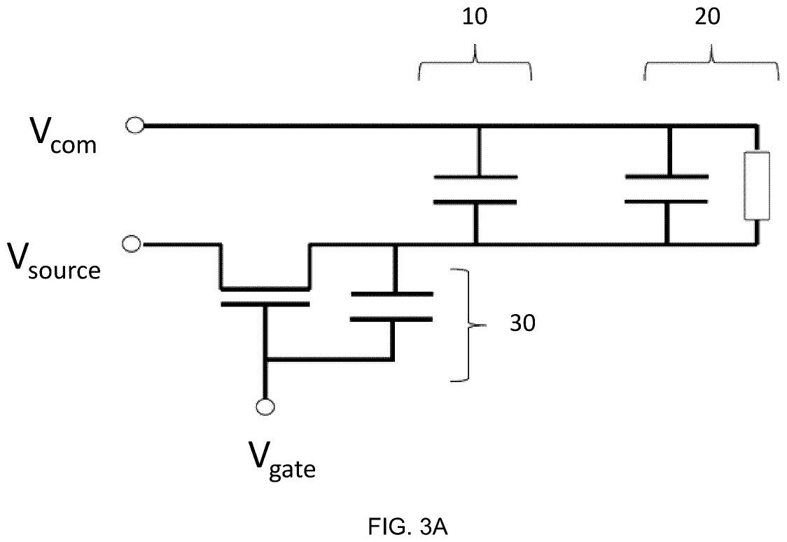

As illustrated in FIG. 3A, each transistor (TFT) is connected to a gate line, a data line, and a pixel electrode (propulsion electrode). When there is large enough positive voltage on the TFT gate (or negative depending upon the type of transistor) then there is low impedance between the scan line and pixel electrode coupled to the TFT drain (i.e., Vg “ON” or “OPEN” state), so the voltage on the scan line is transferred to the electrode of the pixel. When there is a negative voltage on the TFT gate, however, then there is high impedance and voltage is stored on the pixel storage capacitor and not affected by the voltage on the scan line as the other pixels are addressed (i.e., Vg “OFF” or “CLOSED”). Thus, ideally, the TFT should act as a digital switch. In practice, there is still a certain amount of resistance when the TFT is in the “ON” setting, so the pixel takes some time to charge. Additionally, voltage can leak from V_{S} to Vₚᵢₓ when the TFT is in the “OFF” setting, causing cross-talk. Increasing the capacitance of the storage capacitor Cₛ reduces cross-talk, but at the cost of rendering the pixels harder to charge, and increasing the charge time. As shown in FIG. 3A, a separate voltage (V_{TOP}) is provided to the top electrode, thus establishing an electric field between the top electrode and the pixel electrode (V_{FPL}). Ultimately, it is the value of V_{FPL} that determines the optical state of the relevant electro-optic medium. While a first side of the storage capacitor is coupled to the pixel electrode, a second side of the storage capacitor is coupled to a separate line (V_{COM}) that allows the charge to be removed from the pixel electrode. See, e.g., U.S. Pat. No. 7,176,880, which is incorporated by reference in its entirety. (In some embodiments, N-type semiconductor (e.g., amorphous silicon) may be used to from the transistors and the “select” and “non-select” voltages applied to the gate electrodes can be positive and negative, respectively.) In some embodiments V_{COM} may be grounded, however there are many different designs for draining charge from the charge capacitor, e.g., as described in U.S. Pat. No. 10,037,735, which is incorporated by reference in its entirety.

One problem with conventional amorphous silicon TFTs is that the operating voltage is limited to roughly ±15V, whereupon the transistors start to leak current and ultimately fail. While the operating range of ±15V is suitable for many two-particle electrophoretic systems, it has been found that having increased voltage ranges makes it easier to separate particles with different zeta potentials, resulting in advanced electrophoretic displays that update faster and have more reproducible colors. One solution for increasing the voltage range to a pixel electrode is to use top plane switching, i.e. whereby the voltage on the top (common) electrode is varied as a function of time. Another solution is to use advance TFT materials, such as metal oxides, to allow for higher voltage-switching, i.e., an operating range of roughly ±28V.

Typically, the TFTs are arranged in a matrix having gate and signal lines to each TFT, as well as a drain electrode typically coupled to a pixel electrode. This active matrix backplane is coupled to an electro-optic medium, e.g., as illustrated in FIGS. 1 and 2, and typically sealed to create a display module 55, as shown in FIG. 3B. Such a display module 55 becomes the focus of a color display 100. The color display 100 will typically include a processor 50, which is configured to coordinate the many functions relating to displaying content on the display module 55, and to transform “standard” images, such as sRGB images to a color regime that best duplicates the image on the display module 55. The processor is typically a mobile processor chip, such as made by Freescale or Qualcomm, although other manufacturers are known. The processor is in frequent communication with the non-transitory memory 70, from which it pulls image files and/or lookup tables to perform the color image transformations described below. The color display 100 may have more than one non-transitory memory chip. The memory 70 may be flash memory. Once the desired image has been converted for display on the display module 55, the specific image instructions are sent to a controller 60, which facilitates voltage sequences being sent to the respective thin film transistors (described above). Such voltages typically originate from one or more power supplies 80, which may include, e.g., a power management integrated chip (PMIC). The color display 100 may additionally include communication module 85, which may implement, e.g., WIFI protocols or BLUETOOTH, and allows the color display 100 to receive images and instructions, which also may be stored in memory 70. The color display 100 may additionally include one or more sensors 90, which may include a temperature sensor and/or a photo sensor, and such information can be fed to the processor 50 to allow the processor to select an optimum lookup-table entry when such lookup-tables are indexed for ambient temperature or incident illumination intensity or spectrum. In some instances, multiple components of the color display 100 can be embedded in a singular integrated circuit. For example, a specialized integrated circuit may fulfill the functions of the processor 50 and the controller 60.

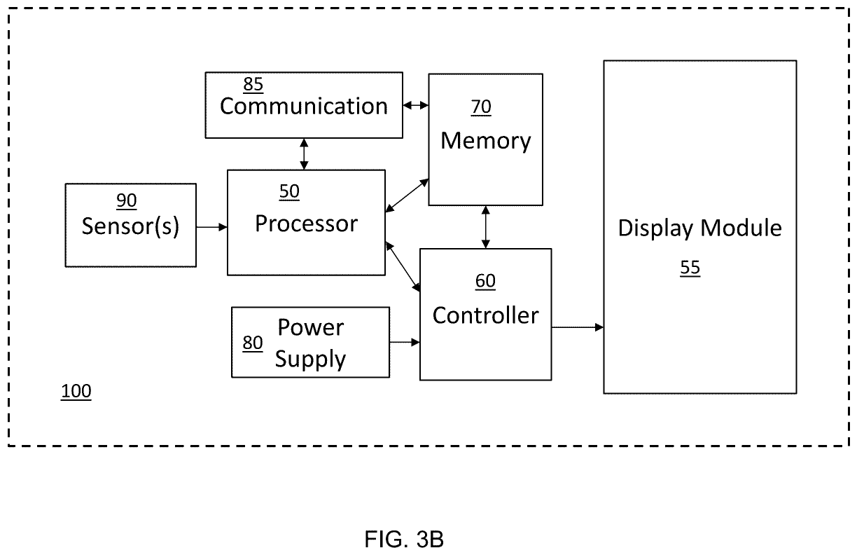

In the instance of ACeP®, each of the eight principal colors (red, green, blue, cyan magenta, yellow, black and white) corresponds to a different arrangement of the four pigments, such that the viewer only sees those colored pigments that are on the viewing side of the white pigment (i.e., the only pigment that scatters light). More specifically, when the cyan, magenta and yellow particles lie below the white particles (Situation [A] in FIG. 4), there are no particles above the white particles and the pixel simply displays a white color. When a single particle is above the white particles, the color of that single particle is displayed, yellow, magenta and cyan in Situations [B], [D], and [F] respectively in FIG. 4. When two particles lie above the white particles, the color displayed is a combination of those of these two particles; in FIG. 4, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 4), all the incoming light is absorbed by the three subtractive primary colored particles and the pixel displays a black color.

It is possible that one subtractive primary color could be rendered by a particle that scatters light, so that the display would comprise two types of light-scattering particle, one of which would be white and another colored. In this case, however, the position of the light-scattering colored particle with respect to the other colored particles overlying the white particle would be important. For example, in rendering the color black (when all three colored particles lie over the white particles) the scattering colored particle cannot lie over the non-scattering colored particles (otherwise they will be partially or completely hidden behind the scattering particle and the color rendered will be that of the scattering colored particle, not black). It would not be easy to render the color black if more than one type of colored particle scattered light.

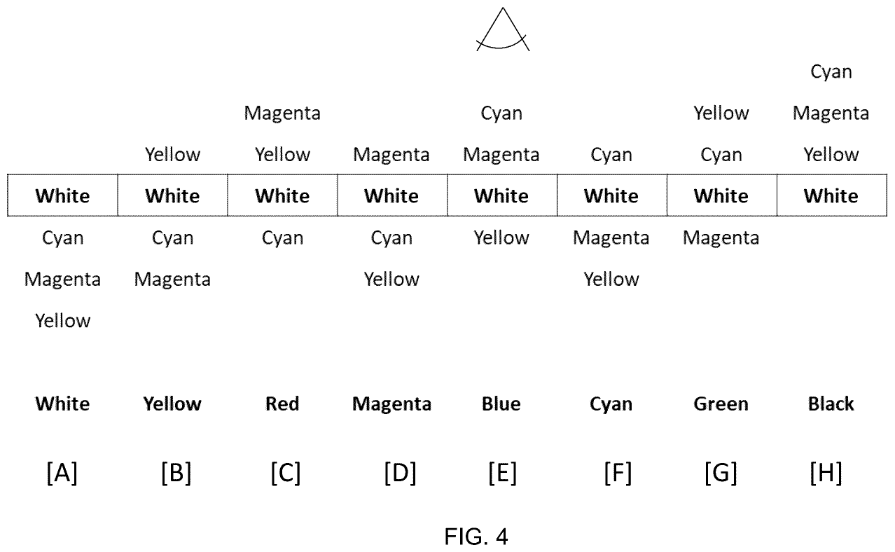

It has been found that waveforms to sort the four pigments into appropriate configurations to make these colors are best achieved with at least seven voltage levels (high positive, medium positive, low positive, zero, low negative, medium negative, high negative). FIG. 5 shows typical waveforms (in simplified form) used to drive a four-particle color electrophoretic display system described above. Such waveforms have a “push-pull” structure: i.e., they consist of a dipole comprising two pulses of opposite polarity. The magnitudes and lengths of these pulses determine the color obtained. In general, the higher the magnitude of the “high” voltages, the better the color gamut achieved by the display. The “high” voltage is typically between 20V and 30V, more typically around 25V, e.g., 24V. The “medium” (M) level is typically between 10V and 20V, more typically around 15V, e.g., 15V or 12V. The “low” (L) level is typically between 3V and 10V, more typically around 7V, e.g., 9V or 5V. Of course, the values for H, M, L will depend somewhat on the composition of the particles, as well as the environment of the electrophoretic medium. In some applications, H, M, L may be set by the cost of the components for producing and controlling these voltage levels.

As shown in FIG. 5, if the top electrode is held at a constant voltage (i.e., not top plane switched), even “simple” waveforms for the ACeP® system require that the driving electronics provide seven different voltages to the data lines during the update of a selected pixel of the display (+H, +M, +L, 0, −L, −M, −H). While multi-level source drivers capable of delivering seven different voltages are available, most commercially-available source drivers for electrophoretic displays permit only three different voltages to be delivered during a single frame (typically a positive voltage, zero, and a negative voltage).

Of course, achieving the desired color with the driving pulses of FIG. 5 is contingent on the particles starting the process from a known state, which is unlikely to be the last color displayed on the pixel. Accordingly, a series of reset pulses precede the driving pulses, which increases the amount of time required to update a pixel from a first color to a second color. The reset pulses are described in greater detail in U.S. Pat. No. 10,593,272, incorporated by reference. The lengths of these pulses (refresh and address) and of any rests (i.e., periods of zero voltage between them may be chosen so that the entire waveform (i.e., the integral of voltage with respect to time over the whole waveform) is DC balanced (i.e., the integral of voltage over time is substantially zero). DC balance can be achieved by adjusting the lengths of the pulses and rests in the reset phase so that the net impulse supplied in the reset phase is equal in magnitude and opposite in sign to the net impulse supplied in the address phase, during which phase the display is switched to a particular desired color.

While modifying the rail voltages provides some flexibility in achieving differing electro-optical performance from a four-particle electrophoretic system, there are many limitations introduced by top-plane switching. For example, it is typically preferred, in order to make a white state with displays of the present invention, that the lower negative voltage V_{M-} is less than half the maximum negative voltage V^{H-}.

An alternative solution to the complications of top-plane switching can be provided by fabricating the control transistors from less-common materials that have a higher electron mobility, thereby allowing the transistors to switch larger control voltages, e.g., +/−30V, directly. Newly-developed active matrix backplanes may include thin film transistors incorporating metal oxide materials, such as tungsten oxide, tin oxide, indium oxide, and zinc oxide. In these applications, a channel formation region is formed for each transistor using such metal oxide materials, allowing faster switching of higher voltages. Such transistors typically include a gate electrode, a gate-insulating film (typically SiO₂), a metal source electrode, a metal drain electrode, and a metal oxide semiconductor film over the gate-insulating film, at least partially overlapping the gate electrode, source electrode, and drain electrode. Such backplanes are available from manufacturers such as Sharp/Foxconn, LG, and BOE.

One preferred metal oxide material for such applications is indium gallium zinc oxide (IGZO). IGZO-TFT has 20-50 times the electron mobility of amorphous silicon. By using IGZO TFTs in an active-matrix backplane, it is possible to provide voltages of greater than 30V via a suitable display driver. Furthermore, a source driver capable of supplying at least five, and preferably seven levels provide a different driving paradigm for a four-particle electrophoretic display system. In an embodiment, there will be two positive voltages, two negative voltages, and zero volts. In another embodiment, there will be three positive voltages, three negative voltages, and zero volts. In an embodiment, there will be four positive voltages, four negative voltages, and zero volts. These levels may be chosen within the range of about −27V to +27V, without the limitations imposed by top plane switching as described above.

Using advanced backplanes, such as metal oxide backplanes, it is possible to directly address each pixel with a suitable push-pull waveform, i.e., as described in FIG. 5. This greatly reduces the time required to update each pixel, in some instances, transforming a six-second update to less than one second. While, in some cases, it may be necessary to use reset pulses to establish a starting point for addressing, the reset can be done quicker at higher voltages. Additionally, in four-color electrophoretic displays having reduced color sets, it is possible to directly drive from a first color to a second color with a specific waveform that is only slightly longer than the push-pull waveforms shown in FIG. 5.

While it is possible to simply produce eight primary colors, as illustrated in FIGS. 4 and 5, the resulting color space is not compatible with standard RGB image data, e.g., 8-bit RGB color image data. Ideally, the extents of the eight primaries in the reflective color device would be roughly cubical as shown in FIG. 6. In such instances, a simple transformation f(pᵢ) could be used to transform each pixel color assignment to a new pixel assignment in the new device. In this idealized example, it would be trivial to convert any of the trillions of existing RGB images into a new image suitable for use on the new device, e.g., a reflective color electrophoretic display. Unfortunately, commercially-available reflective color devices typically do not have cubical color spaces, and the size and shape of the reflective color space depends upon the illuminating light source and the properties of the display materials. Furthermore, in the instance of electrophoretic displays, the color response can be depend upon other environmental factors, such as temperature, as well as device performance, such as TFT performance and frame rate.

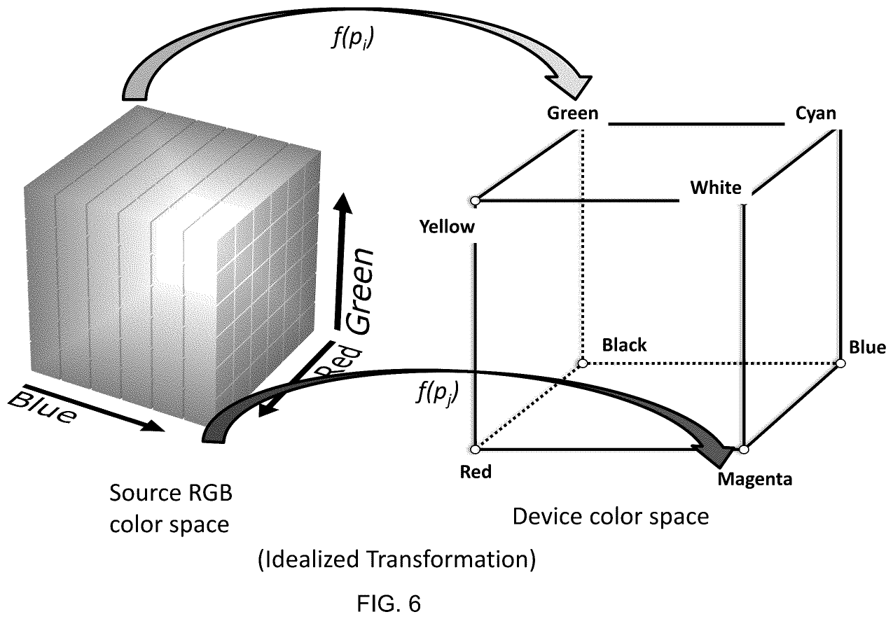

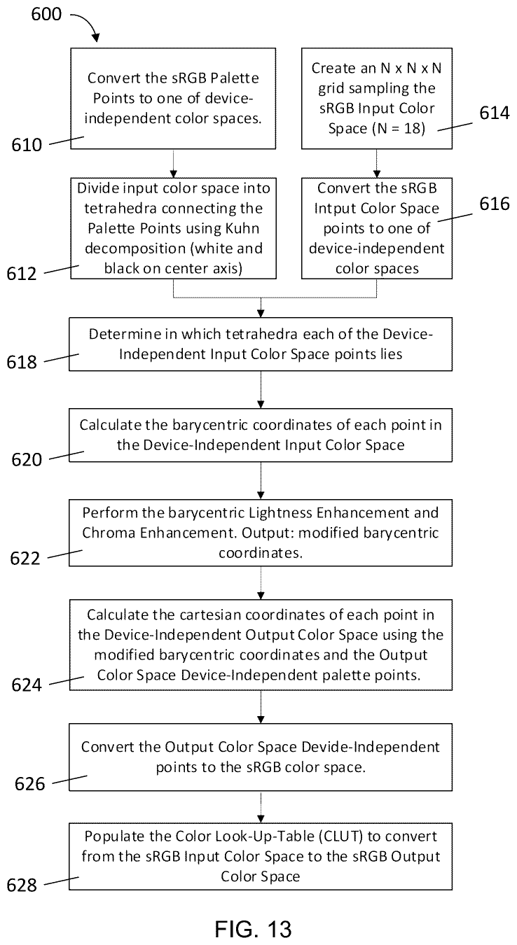

A three step process can be used to transform RGB image data into device image data. One method for transforming RGB image data into ACeP® image data is illustrated in FIGS. 7A-7B. In the first step, the RGB color space and the device color space are deconvolved into a set of tetrahedra, where each tetrahedron includes the K-W axis as well as two other primary color vertices, such as RY. FIG. 7A shows the tetrahedral decomposition of the RGB color space. FIG. 15 shows one example of the same tetrahedra in the device color space. It is only necessary to define six tetrahedra to map the color space, however additional tetrahedra could be created. In a second step, the portion of the image color data that exists in a particular RGB tetrahedra is mapped to the image color data for the device tetrahedra. However, as illustrated in FIG. 7B, the shape of each tetrahedra need not be uniform and typically the device tetrahedra vary in shape and size whereas the RGB tetrahedra are more uniform in shape and size. In the third step, the device image data is reconstructed to produce an image file that is ultimately provided to a controller that provides instructions to the device backplane to produce the required voltages to achieve the requested colors at each pixel.

During the reconstruction of the device image data, the image data can undergo a number of additional steps to improve the perceived quality of the image when displayed on the device. For example, standard dithering algorithms such as error diffusion algorithms (in which the “error” introduced by printing one pixel in a particular color which differs from the color theoretically required at that pixel is distributed among neighboring pixels so that overall the correct color sensation is produced) can be employed with limited palette displays. See, e.g., Pappas, Thrasyvoulos N. “Model-based halftoning of color images,” IEEE Transactions on Image Processing 6.7 (1997): 1014-1024, which is incorporated by reference in its entirety. The reconstruction can also compensate for errors in the device, such as “blooming” wherein the electric field generated by a pixel electrode affects an area of the electro-optic medium wider than that of the pixel electrode itself so that, in effect, one pixel's optical state spreads out into parts of the areas of adjacent pixels.

In another example, when implementing the color mapping, it is assumed that the input colors can be represented as a linear combination of multi-primaries. In a system described herein, this is achieved by gamut mapping the input to the device space color gamut by using a linear combination of multi-primaries (a.k.a. separation cumulate). Such a cumulate is easily dithered by establishing device primary thresholds. In alternative language, each color C in the device image can be defined as

$$C = {\sum }_{i = 1 , … N} {α}_{i} ( C ) {P}_{i} 0 \leq {α}_{1} \leq 1 \cdot \sum {α}_{i} = 1$$

Where Pi is the color of a given primary i in La*b* space. The partial sums of these weights is referred to as separation cumulate Λₖ(C), where

$${Λ}_{k} ( C ) = {\sum }_{i = 1 , … k} {α}_{i} ( C )$$

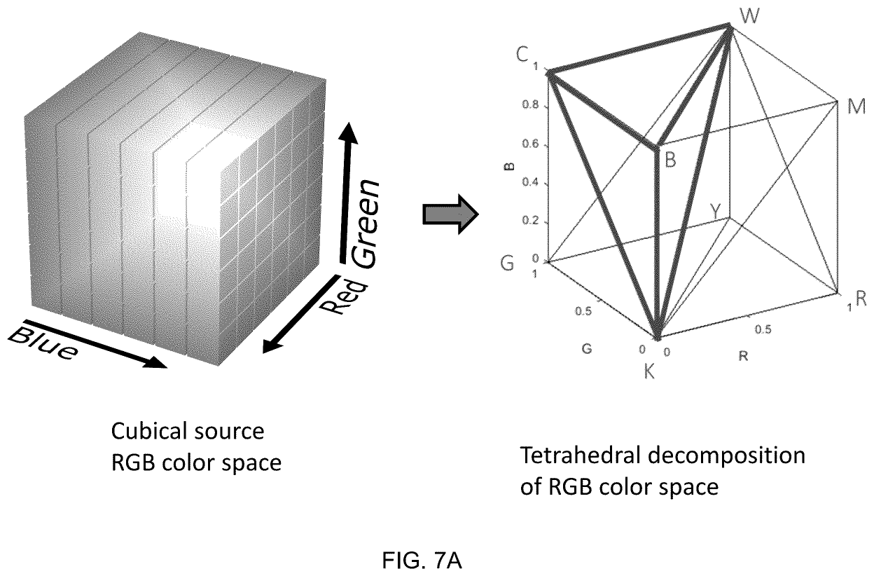

In advanced examples, a multi-color rendering algorithm is integrated into the color mapping process as illustrated in FIG. 8, all of which steps are performed by one or more processors. Such processors are typically specially constructed for use with portable (mobile) displays, to efficiently distribute the computational steps to save energy. See, e.g., processors from Freescale or Qualcomm. As shown, standard RGB image data im_{i,j} may be firstly fed through a number of clean-up steps, which may include a sharpening filter 202, which may be optional in some embodiments. This sharpening filter 202 may be useful in some cases when a threshold array T(x) or filter is less sharp than an error diffusion system. This sharpening filter 202 may be a simple finite impulse response (FIR) filter, e.g., 3×3, which may be easily computed. Additionally, though not shown in FIG. 8, the RGB image data can be resized, e.g., from 16-bit to 8 bit, or the actual image can be resized to accommodate for the presence of more pixels in the RGB image than are available on the target device.

Subsequently, color data may be mapped in a color mapping step 204 as discussed above with respect to FIGS. 7A-7B, and color separation may be generated in a separation generation step 206 by methods commonly available in the art, such as using the Barycentric coordinate method, and this color data may be used to index a CSC_LUT lookup table, which can have N-entries per index that gives the desired separation information in the form that is directly needed by the mask based dithering step (e.g., step 212). In one example, this CSC_LUT lookup table may be built by combining both a desired color enhancement and/or gamut mapping, and the chosen separation algorithm, and is configured to include a mapping between the input image's color values and the color separation cumulate. In this fashion, the lookup table (e.g., CSC_LUT) may be designed to provide the desired separation cumulate information quickly and in the form that is directly needed by the mask based dithering step (e.g., step 212 with the quantizer). Finally, the separation cumulate data 208 is used with a threshold array 210 to generate device image data yij using a quantizer 212 to generate multiple colors. The quantizer may be a separate integrated circuit, however this function is typically incorporated into the processor 50. In one example, the color mapping 204, separation generation 206 and cumulate 208 step may be implemented as a single interpolated CSC_LUT lookup table. In this configuration, the separation stage is not done by finding Barycentric coordinates in a tetrahedralization of the multi-primaries, but may be implemented by a lookup table, which allows more flexibility. In addition, output computed by the method illustrated herein is computed completely independently of the other outputs. Furthermore, the threshold array T(x) used herein may be a Blue Noise Mask (BNM).

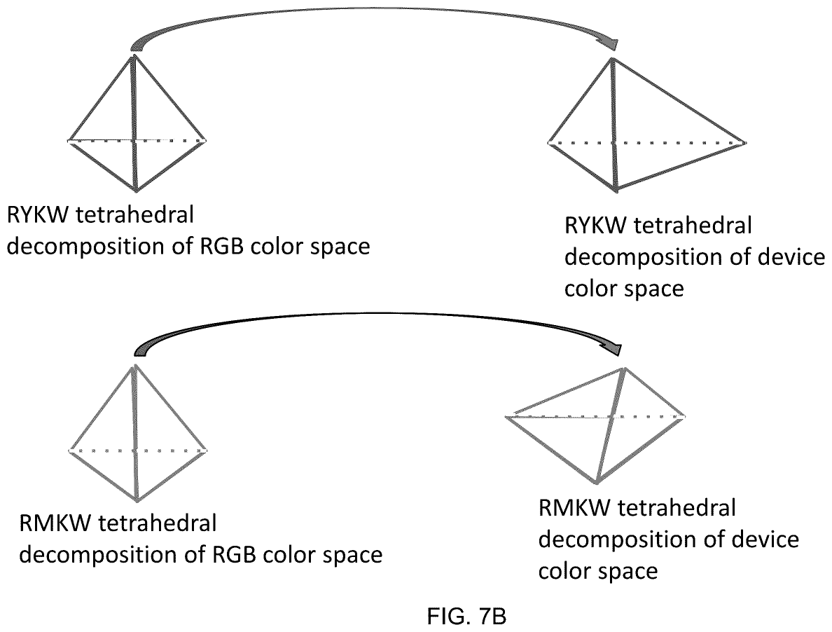

A complete sequence 300 of the conversion from RGB image data, e.g., as included in a .jpeg, .png, or bitmap file, to an image on an electrophoretic color display is shown in FIG. 9. Beginning at step 310 an image file, such as RGB data, is provided. The RGB data may be conditioned, resized, smoothed, sharpened, brightened, etc. in step 320. The resulting RGB data is mapped onto the device color space in step 330 as discussed above with respect to FIGS. 7A-7B. In practice, the color mapping step is typically accomplished with a lookup table 335, which maps the RGB data to the device data based upon pre-existing measurements of device performance, e.g., with a calibrated test pattern and a color optical bench. In many instances, the lookup table will be dynamic and change depending upon measurements of device performance 333 (battery, front light, frame rate) as well as environmental data 338 such as temperature. In some embodiments, the device will have non-transitory memory for storing a plurality of lookup tables 335 indexed for device performance 333 and environmental data 338.

The resulting device image data 340 may be dithered using, e.g., a Barycentric coordinate method at step 350. The device image data may also undergo error diffusion to compensate for blooming. Once the final device image data is converted, the device image data is stored in memory until it is delivered to the controller 360, which ultimately instructs the gate and source drivers to deliver suitable voltages to the front electrode and display pixels in order to display the desired image on the device 370.

### Color Enhancement in Rendered Images

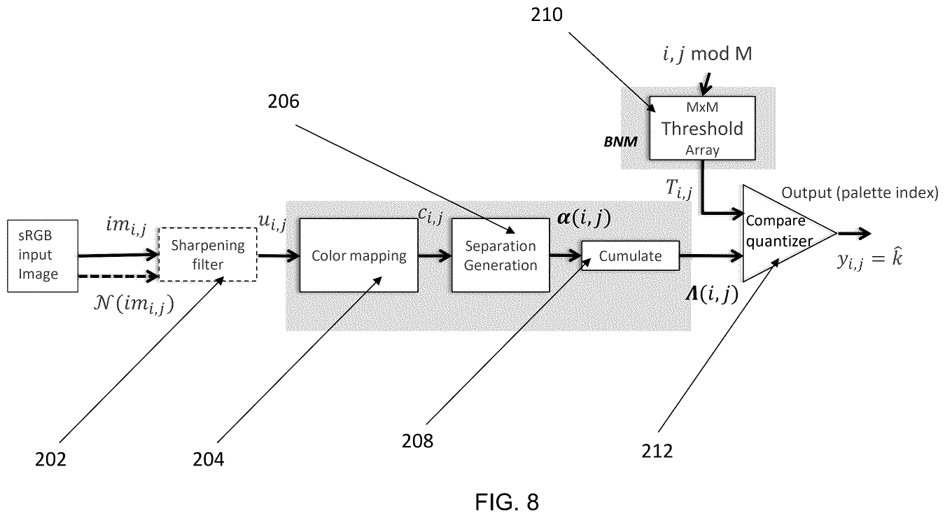

The present disclosure relates to the enhancement of colors in images rendered on electrophoretic displays. According to a first aspect of the invention, an RGB input color space (ICS) enhancement process is disclosed. The process includes brightness enhancement, contrast enhancement, and saturation enhancement of rendered images. An exemplary RGB ICS enhancement method 400 is illustrated in FIG. 10.

At step 410, an sRGB ICS cube (schematically illustrated in FIG. 11) is divided into a plurality of tetrahedra using Kuhn decomposition. Each tetrahedron of the plurality of tetrahedra is defined by a white palette primary (PP) point, a black PP point, and two adjacent color PP points. Any point within a given tetrahedron is produced on an output device using a combination of the four points within the tetrahedron. In parallel, at step 412, an N×N×N grid of points sampling the sRGB ICS is generated (heretofore referred to as “grid points”). N is nominally 18 because it is easy to make a uniform LUT of 8 bit values between 0 and 255 because 17*15=255, which allows input values to access directly the LUT entry without interpolation. However, other numbers can be used. Next, at step 414, the brightness enhancement, contrast enhancements, and saturation enhancements are applied in serial, allowing for one or more of the three enhancements to be skipped if desired. Then, at step 416, a determination is made as to which of the six ICS tetrahedra each of the grid points is located. At step 418, the grid points are converted from sRGB to the Barycentric coordinates of their respective tetrahedra. At step 420, the Cartesian coordinates of each point in the sRGB OCS is calculated using the modified Barycentric coordinates and the OCS sRGB palette points. At step 422, a color lookup table (CLUT) is populated to convert from the sRGB ICS to the sRGB OCS.

### Brightness Enhancement

Brightness enhancement is the first step in the RGB ICS enhancement process. An image, I, contains three channels k=[1,2,3]. A particular channel, k, of image I, can be written as I(:,:,k). The brightness enhancement is performed on each channel independently. For a channel, k, the minimum pixel value, C_{min,k}, and maximum pixel values, C_{max,k}, are first calculated,

$$\begin{matrix}{C}_{min , k} = min ( I ( : , : , k ) ) \\ {C}_{max , k} = max ( I ( : , : , k ) ) .\end{matrix} \qquad 1$$

A value, mₖ, is calculated from C_{min,k} and C_{max,k}. The value mₖ approaches 1 when the difference between C_{min,k} and C_{max,k} is lesser and approaches 0 when the difference between C_{min,k} and C_{max,k} is greater.

$${m}_{k} = 1 - {C}_{max , k} + {C}_{min , k} \qquad 2$$

The value Gₖ is the ratio of C_{min,k} and mₖ, raised to the power γ₁. If mₖ approaches 1, then Gₖ approaches

$${C}_{min , k}^{{γ}_{1}} ,$$

and as mₖ approaches 0, Gₖ becomes increasingly large.

$${G}_{k} = {( \frac{{c}_{min , k}}{{m}_{k}} )}^{{γ}_{1}} \qquad 3$$

A sigmoidal function, based on the standard normal cumulative distribution function (Eq. 4) modulates Gₖ, flatting lower and higher values, and sharpening middle values.

$$f ( x : μ , σ ) = \frac{1}{\sqrt{π}} {\int }_{x}^{∞} {{e}^{( \frac{( x - μ )}{\sqrt{2 {σ}^{2}}} )}}^{2} \qquad 4$$

The parameters μ and σ control the shape of the CDF curve, CDFRₖ(Gₖ) (Eq. 5).

$${CDF}_{k} ( {G}_{k} ) = f ( {G}_{k} : μ , σ ) \qquad 5$$

Gₖ is normalized to the range [0, 1],

$${G}_{k}^{′} = \frac{{CDF}_{k} ( {G}_{k} ) - min ( CDF )}{max ( CDF ) - min ( CDF )} \qquad 6$$

with Eq. 6.

$${G}_{k}^{′} = \frac{C D {F}_{k} ( {G}_{k} ) - min ( C D F )}{max ( C D F ) - min ( C D F )} \qquad 6$$

where min(CDF)=f(0:μ,σ) and max(CDF)=f(1:μ,σ). The modified image values, I′(:,:,k) are the sum of the image values, I(:,:,k) and the value,

$$( {m}_{k} {G}_{k}^{′} - {C}_{min , k} )$$

(Eq. 7). The value added to I(:,:,k) goes to 0 as the constant

$${m}_{k} {G}_{k}^{′}$$

approaches C_{min,k}. This means the minimum value in I(:,:,k) will not change while large values become larger.

$${I}^{′} ( : , : , k ) = I ( : , : , k ) + ( {m}_{k} {G}_{k}^{′} - {C}_{min , k} ) \qquad 7$$

### Contrast Enhancement

Contrast enhancement follows the brightness enhancement. The brightness-enhanced image, I′(:,:,k), is first reshaped from an m×n×3 array to a 3×m*n array,

$${I}_{R}^{′} ( k , : )$$

(Eq. 8).

$$( m , n , k ) = size ( {I}^{′} ) \qquad 8$$

$${I}_{R}^{′} ( k , : ) = reshape ( {I}^{′} , m * n , k )$$

The reshaped image is converted to the YC_{b}Cᵣ color space, an opponent-like color space based on RGB that separates the luminance channel, Y, from the chrominance channels C_{b} and Cᵣ. The transformation is performed using Eq. 9,

$$[ \begin{matrix}Y \\ {C}_{b} \\ {C}_{r}\end{matrix} ] = M [ \begin{matrix}{I}_{R}^{′} ( 1 , : ) \\ {I}_{R}^{′} ( 2 , : ) \\ {I}_{R}^{′} ( 3 , : )\end{matrix} ] \qquad 9$$

$$where ,$$

$$M = [ \begin{matrix}0.299 & 0.587 & 0.114 \\ 0.169 & - 0.331 & 0.5 \\ 0.5 & - 0.419 & - 0.081\end{matrix} ] \qquad 10$$

A modified Y value, Y′, is calculated using Eq. 11, a type of sigmoid function with the shape parameter β.

$${Y}^{′} = \frac{1}{1 + {( \frac{Y ( : )}{1 - Y ( : )} )}^{- β}} \qquad 11$$

The contrast-enhanced image parameters are calculated using Eq. 12, where M⁻¹ is the inverse of the matrix M.

$$[ \begin{matrix}{I}^{″} ( 1 , : ) \\ {I}^{″} ( 2 , : ) \\ {I}^{″} ( 3 , : )\end{matrix} ] = {M}^{- 1} [ \begin{matrix}{Y}^{′} \\ {C}_{b} \\ {C}_{r}\end{matrix} ] \qquad 12$$

### Saturation Enhancement

The third stage in the RGB ICS Enhancement is saturation enhancement. The minimum and maximum color coordinate for each pixel of the contrast-enhanced image values,

$${C}_{min , k}^{″} and {C}_{max , k}^{″} ,$$

are calculated using Eq. 13.

$${C}_{min , k}^{″} = min ( {I}^{″} ( k , : ) ) \qquad 13$$

$${C}_{max , k}^{″} = max ( {I}^{″} ( k , : ) )$$

A magnitude parameter,

$${m}_{k}^{″} ,$$

is the difference between

$${C}_{min , k}^{″} and {C}_{max , k}^{″} .$$

The value

$${m}_{k}^{″}$$

goes to 0 when

$${C}_{min , k}^{″} = {C}_{max , k}^{″} . \qquad 14$$

$${m}_{k}^{″} = {C}_{max , k}^{″} - {C}_{min , k}^{″}$$

A parameter s, calculated using Eq. 15, controls the amount of saturation enhancement. The value gets larger as the difference between

$${C}_{min , k}^{′′} and {C}_{max , k}^{′′}$$

increases.

$$s = \frac{{C}_{min}^{′′}}{( 1 - {m}_{k}^{′′} )} \qquad 15$$

A vector g is created from a 3×1 array of s (Eq. 16).

$$g = s * [ 1 , 1 , 1 ] \qquad 16$$

The saturation enhanced image values are calculated using Eq. 17. The vector g is subtracted from I″(k,:). The difference is multiplied by a parameter h, calculated using Eq. 18, and added back to g. Removing the gray components essentially allows the chromatic components to be modified independent of the gray component, which is then added back to the chromatic component. This saturation enhancement amplifies channels where there is a larger disparity between light and dark values.

$${I}^{′′′} ( k , : ) = h ( {I}^{′′} ( k , : ) - {g}_{k} ) + {g}_{k} \qquad 17$$

$$h = {( {m}_{k}^{′′0 \text{.3}} + 1 - {m}_{k}^{′′} )}^{{γ}_{2}} \qquad 18$$

The RGB ICS enhancement method thus compensates for the losses in brightness, contrast, and saturation that result from mapping to a small OCS by modifying the source image. The process parameters can be tuned to achieve an optimal image. However, a three-stage approach can be complex. The five tunable parameters—γ₁, γ₂, μ, σ, and β—should be configured, and the user decides whether to use all three enhancements, only one enhancement, or a pair of enhancements to achieve an optimal result. In addition, the RGB enhancement method may make it difficult to adapt to changing sets of OCS PP's, the primaries that define the gamut cusps. An enhancement that is optimal for one set of OCS PP's, might not be optimal for another. Further aspects of the invention described below provide a simplified two-stage approach and perform the enhancements in Barycentric coordinates. The use of Barycentric coordinates removes the dependency of the correction on the OCS PP's and instead makes it universal. That is not to say that a pleasing result can be achieved with every set of OCS PP's—there is much dependency on the points themselves—but that the optimal enhancement with one set of OCS PPs should also look reasonable with a different set of points.

In accordance with a second aspect of the invention, color gamut mapping is performed using a direct transformation from a device-dependent ICS to a device-dependent OCS. The ICS and OCS are defined using a three-dimensional color space (e.g., sRGB). The ICS can be described as a cube as shown in FIG. 11, where each of the eight vertices—Black, White, Red, Green, Blue, Cyan, Magenta, and Yellow—is described in the sRGB color space and has a value of either 0 or 1 (0 is “off” and 1 is “on”), e.g., Red=[1, 0, 0], Magenta=[1, 0, 1].

The OCS can be described as an asymmetric polyhedron with eight vertices. The vertices represent each of the eight colors that can be created on the display and comprise the colors of rendered images. These real colors are described in one of the device-independent color spaces (including, but not limited to, spectral reflectance, CIE XYZ, CIE L*a*b*, and IPT). From the color values of the device-independent color spaces are derived color values from one of a plurality of device-dependent color spaces (including, but not limited to, sRGB, Adobe RGB). The eight OCS vertices comprise the PPs. The eight OCS PPs are within the ICS “gamut”, the convex hull of all reproducible colors in the color space. Thus, each of the eight OCS PPs is located within the ICS gamut, and so have values less than one (e.g., Red=[0.57, 0.39, 0.32], Magenta=[0.50, 0.33, 0.39]).

The process of transforming sRGB points in the ICS image to sRGB points in the OCS is called “gamut mapping.” There are many gamut mapping techniques known in the art (see, e.g., J. Morovic, Color Gamut Mapping, Chichester, West Sussex: John Wiley & Sons, Ltd., 2008). Various embodiments of the present invention use a gamut mapping method whereby the sRGB pixel values in the input image, described in the ICS, are transformed to OCS sRGB pixel values via a CLUT. A novel approach is presented in one or more embodiments for enhancing colors in the output image during the process of generating the CLUT.

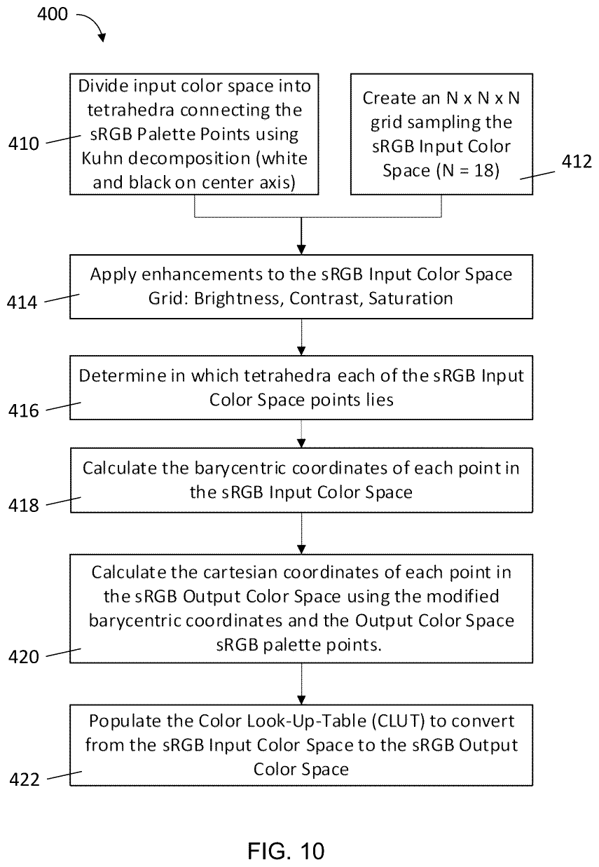

FIG. 12 is a flow chart illustrating an exemplary image enhancement method 500 in accordance with a second aspect of the invention. At step 510, the sRGB ICS cube (depicted in FIG. 11) is divided into a plurality of tetrahedra, each of which is defined by the white PP point, the black PP point, and two adjacent color PP points. Any point within a given tetrahedron is produced on the output device using a combination of the four points within the tetrahedron. In parallel, at step 512, an N×N×N grid of points sampling the sRGB ICS (the “grid points”) is generated. N is nominally 18 but can be any reasonable number. Next, at step 514, a determination is made as to which of the eight ICS tetrahedra each of the grid points is located. The grid points are converted from sRGB to the Barycentric coordinates of their respective tetrahedron at step 516, at which point the novel color enhancements (lightness and chroma) are applied at step 518. Finally, the grid points are converted from the enhanced Barycentric coordinates to Cartesian coordinates of the OCS at step 520 to populate the final CLUT at step 522.

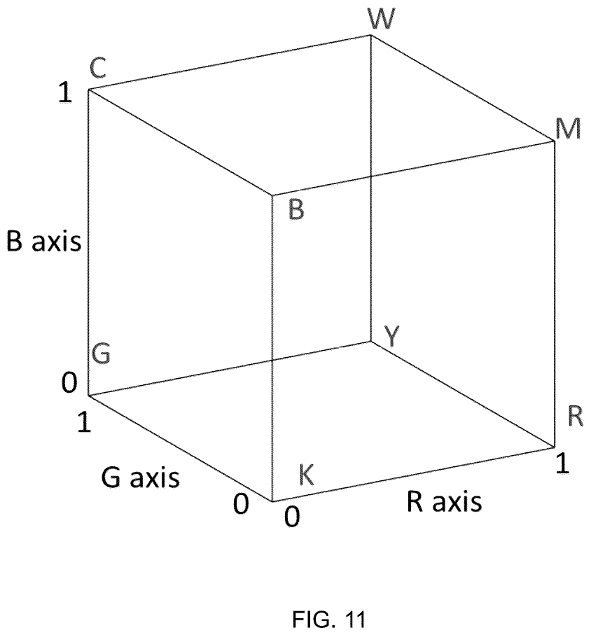

FIG. 13 is a flow chart illustrating an exemplary image enhancement method 600 in accordance with a third aspect of the invention. At step 610, the vertices of the sRGB ICS cube (shown in FIG. 11) are converted to values of a device independent color spaces (including, but not limited to, spectral reflectance, CIE XYZ, CIE L*a*b*, and IPT). At step 612, the ICS, with eight vertices described in device-independent coordinates, is divided into a plurality of tetrahedra, each of which is defined by a white PP point, a black PP point, and two adjacent color PP points. Any point within a given tetrahedron is produced on the output device using a combination of the four points within said tetrahedron. In parallel, at step 614, an N×N×N set of sRGB ICS grid points is sampled and converted to the values of the same device-independent color space (including, but not limited to, spectral reflectance, CIE XYZ, CIE L*a*b*, and IPT) as the ICS vertices at step 616. Next, at step 618, a determination is made as to which of the eight ICS tetrahedra each of the grid points is located. They are converted from the device-independent color space to the Barycentric coordinates of their respective tetrahedra (step 620), at which point the novel color enhancements (lightness and chroma) are applied (step 622). The grid points are then converted from the enhanced Barycentric coordinates to Cartesian coordinates in the device-independent color space at step 624, and then finally converted from the device-independent color space to the sRGB color space at step 626. At step 628, the final CLUT is populated for use in converting from the SRGB ICS to the sRGB OCS.

### Gamut Mapping

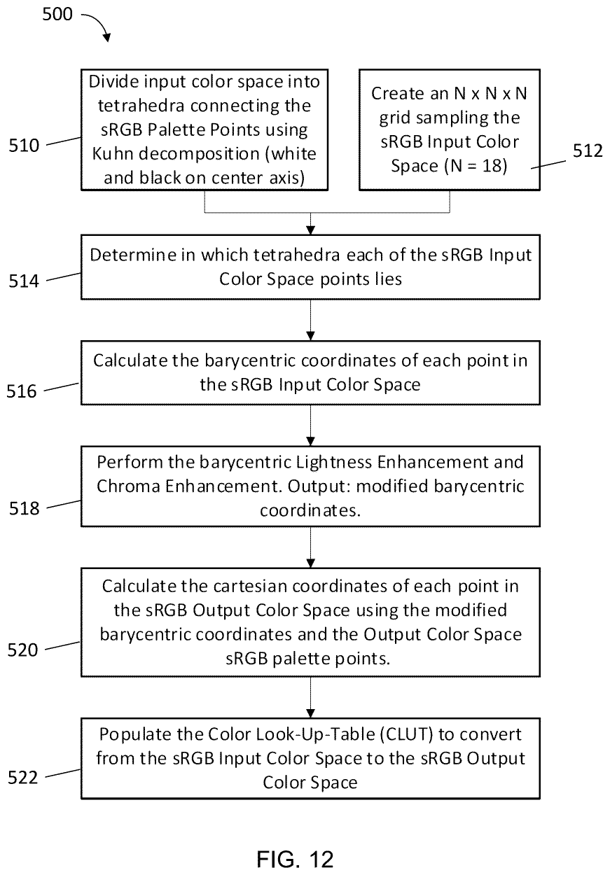

The decomposition of the ICS sRGB gamut cube (shown in FIG. 11) into tetrahedra is illustrated in FIG. 14. The lines bisecting the cube represent the tetrahedra edges. Each tetrahedron has six edges connecting four vertices. All tetrahedra include the white and black vertices and two adjacent color primaries.

The OCS sRGB gamut polyhedron is smaller than the ICS gamut cube. As shown in FIG. 15, the OCS sRGB gamut polyhedron fills only a fraction of the space encompassed by the ICS sRGB gamut cube, represented by the axes of the grid shown on the left side of FIG. 15. A zoomed-in view of the OCS sRGB gamut polyhedron is shown on the right side of FIG. 15. As shown, the polyhedron shape is a significant departure from a cube, although the PPs maintain the same respective adjacency as the ICS cube vertices.

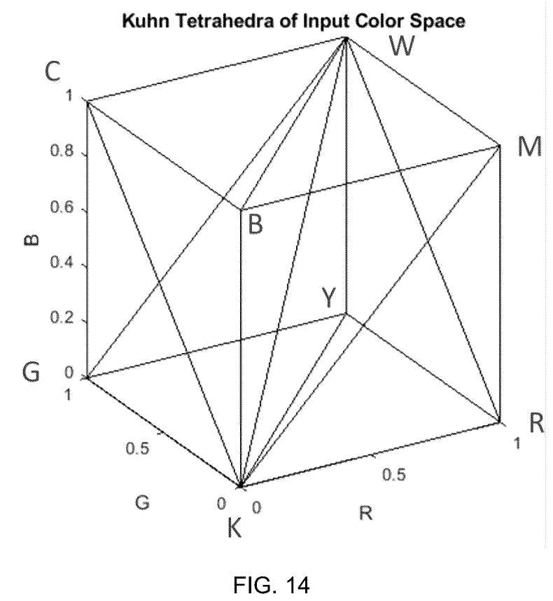

The gamut mapping process, using the CLUT, assigns sample points in the ICS sRGB gamut cube, in their respective tetrahedra, to the same relative positions within their respective tetrahedra in the OCS sRGB gamut polyhedron. Vertices in the ICS are always mapped to respective PPs in the OCS (e.g., white to white, red to red, magenta to magenta), although the color values for respective points differ, as depicted in FIG. 16.

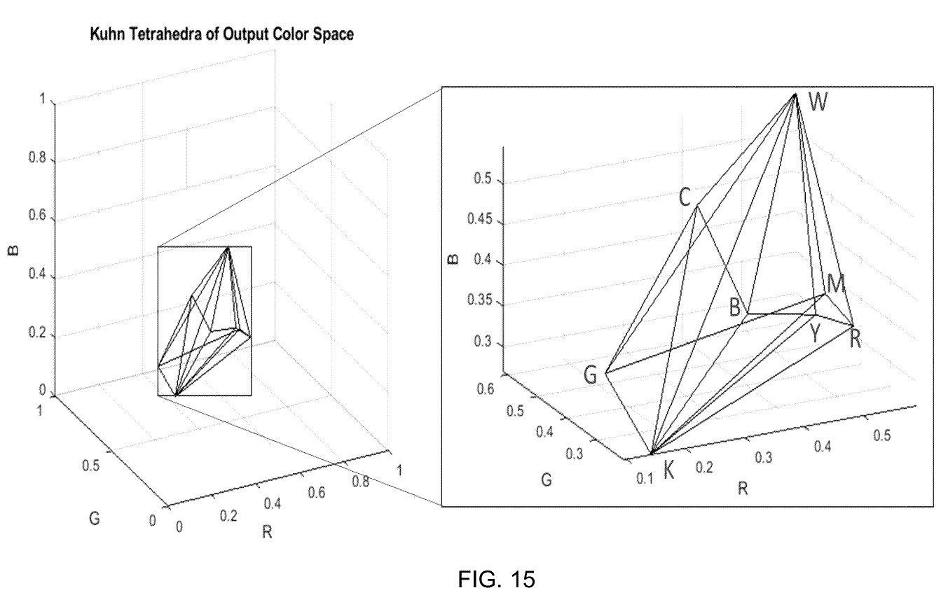

Sample points within each ICS tetrahedron are mapped to the same relative positions in the respective OCS tetrahedron. For example, FIG. 17 shows two triangles representing an ICS and OCS with three colors: white, black, and C₁ (an arbitrary color). The OCS is smaller and contained entirely within the ICS.

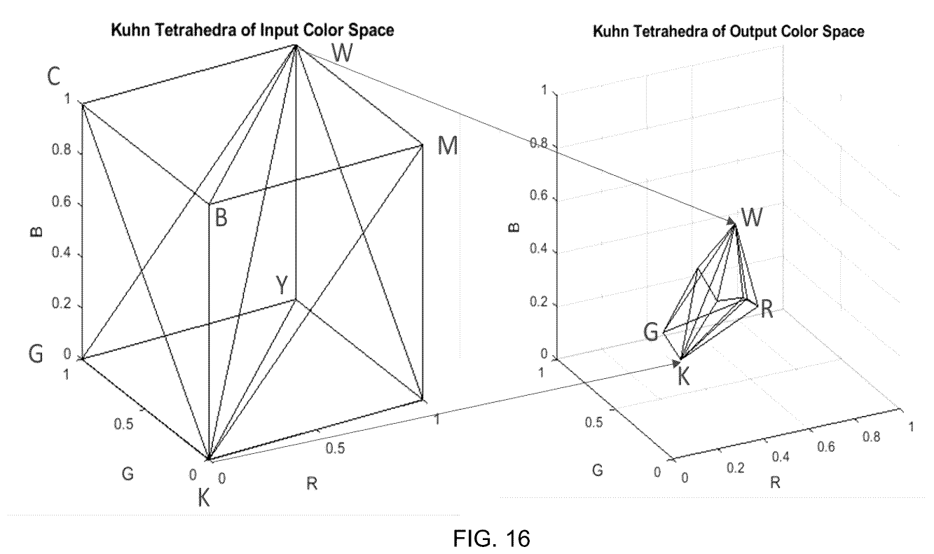

A point, Xᵢ, is mapped from its position in the ICS to its relative position in the OCS, Xₒ, in FIG. 18. Xₒ shares the same relative position in the OCS as Xᵢ does in the ICS. This type of mapping is a result of gamut mapping being performed by the transformation of Barycentric coordinates, as outlined in FIGS. 12 and 13.

### Barycentric Coordinates

The application of Barycentric coordinates in gamut mapping is known in the art. See, e.g., U.S. Pat. No. 6,304,333; Z. Baharav and D. Shaked, “Dithering in a Simplex,” Hewlett Packard, Haifa, IL, 1999; and V. Ostromoukhov and R. D. Hersch, “Multi-Color and Artistic Dithering,” in SIGGRAPH, Los Angeles, CA, 1999.

Barycentric coordinates describe the relative amounts of PPs in a given tetrahedron that are additively mixed to create a sample point within that tetrahedron. A tetrahedron contains four PPs. Every point, X, within a tetrahedron comprising PPs C₁, C₂, C₃, and C₄, can be expressed using the formulas in Eq. 19, where αᵢ are the Barycentric coordinates. The Barycentric coordinates are all positive (a negative coordinate would mean X is outside the tetrahedron) and must sum to 1.

$${α}_{1} {C}_{1} + {α}_{2} {C}_{2} + {α}_{3} {C}_{3} + {α}_{4} {C}_{4} = X \qquad 19$$

$${α}_{1} + {α}_{2} + {α}_{3} + {α}_{4} = 1$$

The Cartesian coordinates of each PPᵢ (Eq. 20) are described in the FIG. 12 embodiment of a plurality of device-dependent color coordinates (including, but not limited to, SRGB, Adobe RGB), and in the FIG. 13 embodiment by one of a plurality of device-independent coordinates (including, but not limited to, spectral reflectance, CIE XYZ, CIE L*a*b*, and IPT). For simplicity, the device-dependent color coordinates are referred to as “′sRGB,” or “RGB.”

$${C}_{i} = [ \begin{matrix}{R}_{i} \\ {G}_{i} \\ {B}_{i}\end{matrix} ] \qquad 20$$

The Cartesian coordinates of the point, X_{I,n}, in the ICS (X_{I,n}, Eq. 21) and the point X_{O,n}, in the OCS (X_{O,n}, Eq. 21) are described in the FIG. 12 embodiment by sRGB device-dependent coordinates, and in the FIG. 13 embodiment by one of a plurality of device-independent coordinates (including, but not limited to, spectral reflectance, CIE XYZ, CIE L*a*b*, and IPT).

$${X}_{I , n} = [ \begin{matrix}{R}_{I , n} \\ {G}_{I , n} \\ {B}_{I , n}\end{matrix} ] , {X}_{O , n} = [ \begin{matrix}{R}_{O , n} \\ {G}_{O , n} \\ {B}_{O , n}\end{matrix} ] , \qquad 21$$

The system of linear equations in Eq. 19 is represented for the ICS in matrix form in Eq. 22.

$$[ \begin{matrix}1 & 1 & 1 & 1 \\ {R}_{I , 1} & {R}_{I , 2} & {R}_{I , 3} & {R}_{I , 4} \\ {G}_{I , 1} & {G}_{I , 2} & {G}_{I , 3} & {G}_{I , 4} \\ {B}_{I , 1} & {B}_{I , 2} & {B}_{I , 3} & {B}_{I , 4}\end{matrix} ] [ \begin{matrix}\begin{matrix}\begin{matrix}{α}_{1. n} \\ {α}_{2. n}\end{matrix} \\ {α}_{3. n}\end{matrix} \\ {α}_{4. n}\end{matrix} ] = [ \begin{matrix}\begin{matrix}\begin{matrix}1 \\ {R}_{I , n}\end{matrix} \\ {G}_{I , n}\end{matrix} \\ {B}_{I , n}\end{matrix} ] \qquad 22$$

The Cartesian coordinates of the four ICS PPs and of the point X_{I,n} in the ICS are known. The Barycentric coordinates are calculated by solving Eq. 23.

$$[ \begin{matrix}\begin{matrix}\begin{matrix}{α}_{1. n} \\ {α}_{2. n}\end{matrix} \\ {α}_{3. n}\end{matrix} \\ {α}_{4. n}\end{matrix} ] = {[ \begin{matrix}1 & 1 & 1 & 1 \\ {R}_{I , 1} & {R}_{I , 2} & {R}_{I , 3} & {R}_{I , 4} \\ {G}_{I , 1} & {G}_{I , 2} & {G}_{I , 3} & {G}_{I , 4} \\ {B}_{I , 1} & {B}_{I , 2} & {B}_{I , 3} & {B}_{I , 4}\end{matrix} ]}^{- 1} [ \begin{matrix}\begin{matrix}\begin{matrix}1 \\ {R}_{I , n}\end{matrix} \\ {G}_{I , n}\end{matrix} \\ {B}_{I , n}\end{matrix} ] \qquad 23$$

Since the ICS and OCS share common tetrahedra indices, the Barycentric coordinates calculated using Eq. 23 can be used to calculate the Cartesian coordinates of the point X_{O,n} in the OCS using Eq. 24 and the known Cartesian coordinates of the OCS PPs.

$$[ \begin{matrix}1 & 1 & 1 & 1 \\ {R}_{O , 1} & {R}_{O , 2} & {R}_{O , 3} & {R}_{O , 4} \\ {G}_{O , 1} & {G}_{O , 2} & {G}_{O , 3} & {G}_{O , 4} \\ {B}_{O , 1} & {B}_{O , 2} & {B}_{O , 3} & {B}_{O , 4}\end{matrix} ] [ \begin{matrix}\begin{matrix}\begin{matrix}{α}_{1. n} \\ {α}_{2. n}\end{matrix} \\ {α}_{3. n}\end{matrix} \\ {α}_{4. n}\end{matrix} ] = [ \begin{matrix}\begin{matrix}\begin{matrix}1 \\ {R}_{O , n}\end{matrix} \\ {G}_{O , n}\end{matrix} \\ {B}_{O , n}\end{matrix} ] \qquad 24$$

Each tetrahedron contains white and black and two chromatic colors, C₁ and C₂. The Barycentric coordinates thus correspond to these points, shown below.
α₁=α_{W}: proportion of White
α₂=α_{K}: proportion of Black
α₃=α_{C,1}: proportion of Color 1
α₄=α_{C,2}: proportion of Color 2

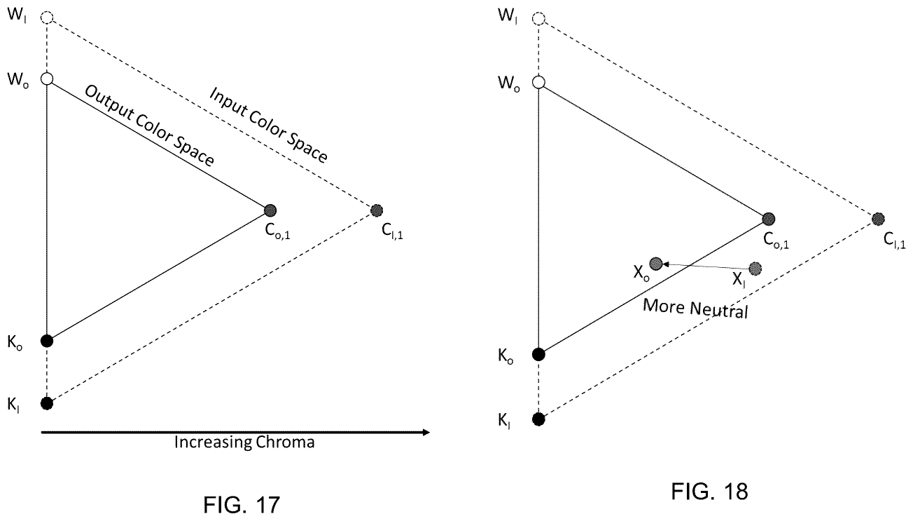

The Barycentric coordinates of the point X_{I} and X_{O} in FIG. 18—α_{W}, α_{K}, and α_{C,1}—are illustrated in FIG. 19. The Barycentric coordinates here represent proportions of the total volume of the ICS and OCS triangles containing PPs white (W), black (K) and C₁. Although the OCS triangle is smaller than the ICS triangle, the volume proportions, and the ratios between them, are constant.

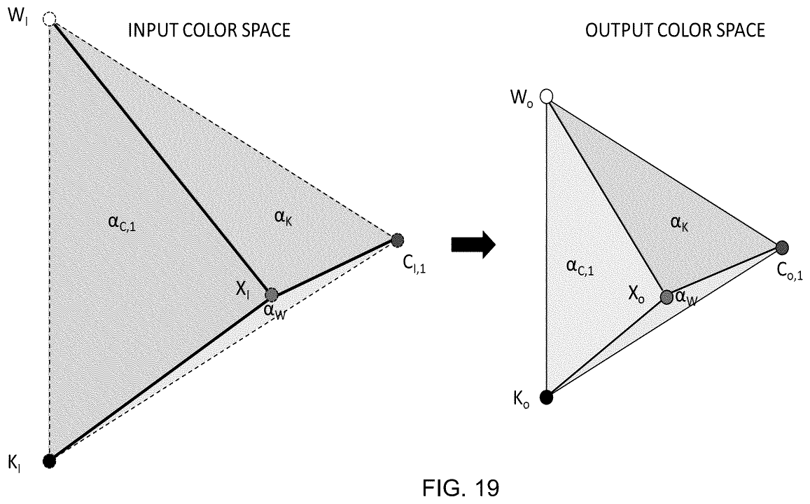

The above illustration of triangular color spaces can be extended to the tetrahedra described herein. The point X_{O} is shown in a tetrahedra consisting of PPs white (W_{O}), black (K_{O}), chromatic color 1 (C_{O,1}), and chromatic color 2 (C_{O,2}) in FIG. 20.

Recalling Eq. 19, the Barycentric coordinates must sum to one. Since all tetrahedra within the Kuhn decomposition contain white, black, and two chromatic components, the Barycentric coordinates can be subdivided into those representing the neutral axis, α_{N}, and those representing a chromatic axis, α_{C}. The neutral axis Barycentric coordinate is the sum of α_{W} and α_{K} (Eq. 25).

$${α}_{N} = {α}_{W} + {α}_{K} \qquad 25$$

The chromatic axis Barycentric coordinate, α_{C}, is the sum of the chromatic component α_{C,1} and α_{C,2} (Eq. 26).

$${α}_{C} = {α}_{C , 1} + {α}_{C , 2} \qquad 26$$

The sum of α_{N} and α_{C} is one (Eq. 27).

$${α}_{N} + {α}_{C} = 1 \qquad 27$$

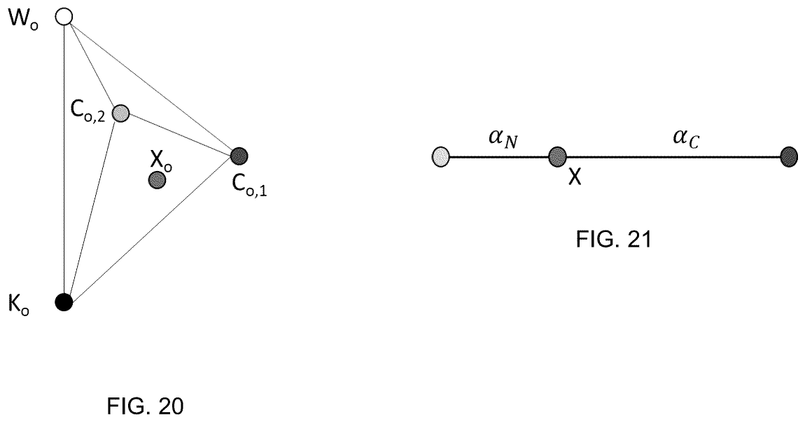

The reduction in Barycentric dimensionality from four to two dimensions is illustrated in FIG. 21. The point, X, is a combination of α_{N} and α_{C}. The color enhancements described below are performed separately for the neutral axis and the chromatic axis. These are referred to as the “lightness” enhancement and “chroma” enhancement. However, the terms “lightness” and “chroma” are used here as representations of the axis of adjustment, as they are not specifically located along the colorimetric lightness and chroma axes.

### Lightness and Chroma Enhancements

Performing enhancements in the Barycentric space ensures that all gamut mapped colors will remain in-gamut after enhancement. The Kuhn decomposition, ensuring all sample points contain both white and black PPs, provides a convenient means of projecting into neutral and chromatic dimensions. While the white and black PPs in the OCS are not necessarily neutral in the colorimetric space, and may change as a function of waveform, they offer maximum neutrality without sacrificing the OCS gamut volume.

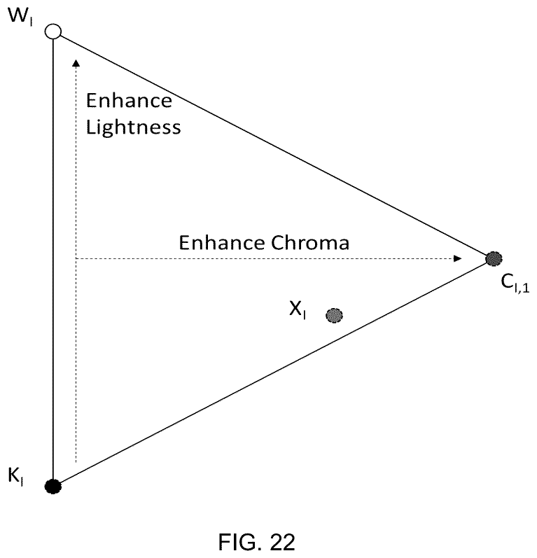

The lightness and chroma enhancements are illustrated using the gamut triangle in FIG. 22. Lightness is enhanced by adjusting the white and black Barycentric coordinates, α_{W} and α_{K}. Chroma is enhanced by adjusting the chromatic Barycentric coordinate, α_{C}, relative to the neutral coordinate, α_{N}. After all enhancements, the Barycentric coordinates must sum to one.

Lightness enhancement is performed by reapportioning the white and black Barycentric coordinates (adding to the white and removing from black). The gamut mapping greatly reduces dynamic range and this must be compensated for by an increase in contrast while preserving the shadows and without clipping the highlights. The Lightness Enhancement is enacted on the white Barycentric coordinate. A sigmoid CDF curve, a type of S-curve like that in Eq. 4, provides the necessary increase in contrast and preservation of shadows. The basic sigmoid structure is given in Eq. 28,

$$CDF ( x : μ , σ ) = \frac{1}{\sqrt{π}} {\int }_{x}^{∞} {e}^{{( \frac{( x - μ )}{\sqrt{2 {σ}^{2}}} )}^{2}} \qquad 28$$

where x is the input value and μ and σ are input parameters (with μ and σ being the mean and standard deviation in a normal distribution). The enhanced white Barycentric coordinate,

$${α}_{W}^{′} ,$$

is a function of the normalized CDF curve given in Eq. 29, where min(CDF) and max(CDF) are given in Eqs. 30 and 31, respectively.

$$f ( x : {μ}_{L} , {σ}_{L} ) = \frac{CDF ( x , {μ}_{L} , {σ}_{L} ) - min ( CDF )}{max ( CDF ) - min ( CDF )} \qquad 29$$

$$min ( CDF ) = CDF ( 0 , {μ}_{L} , {σ}_{L} ) \qquad 30$$

$$max ( CDF ) = CDF ( 1 , {μ}_{L} , {σ}_{L} ) \qquad 31$$

The input to Eq. 29 is the white Barycentric coordinate raised to a an exponent, γ_{L},

$${α}_{W}^{γ L}$$

The final modified white Barycentric coordinate must be normalized by α_{N} to preserve the unit sum of the Barycentric coordinates. The full equation for

$${α}_{W}^{′}$$

is given in Eq. 32.

$${α}_{W}^{′} = f ( {α}_{W}^{γ L} ) {α}_{N} \qquad 32$$

The modified black Barycentric coordinate is calculated using Eq. 33.

$${α}_{K}^{′} = {α}_{N} - {α}_{W}^{′} \qquad 33$$

The full set of lightness-enhanced Barycentric coordinates is given in Eq. 34. Only the white and black coordinates have been modified at this point, while the coordinates of the two chromatic PPs remain the same and all sum to one. The sum

$$\begin{matrix}{α}_{W}^{′} + {α}_{K}^{′} = {α}_{N} . \\ {α}^{′} = [ {α}_{W}^{′} , {α}_{K}^{′} , {α}_{C , 1} , {α}_{C , 2} ]\end{matrix} \qquad 34$$

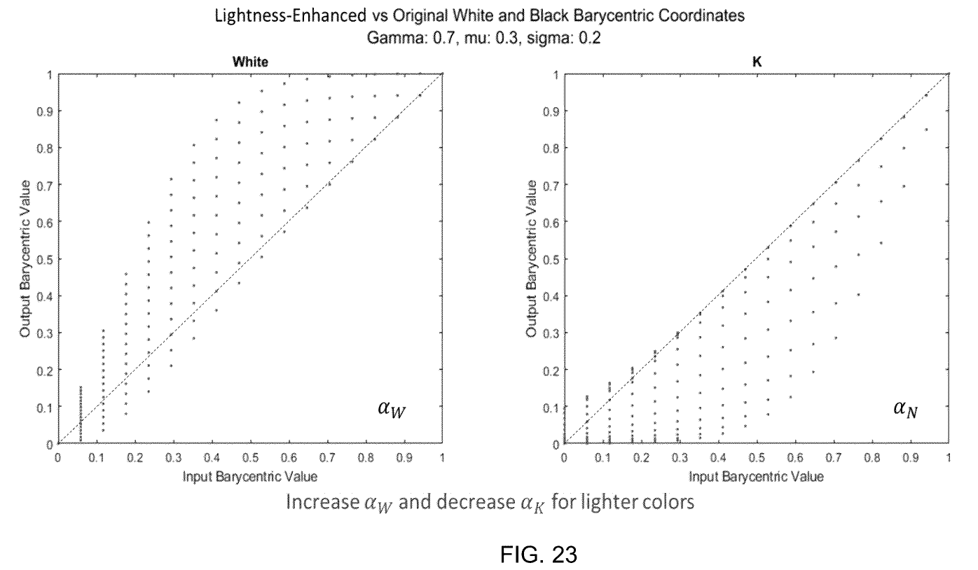

A plot of the white and black Barycentric coordinates before and after lightness enhancement is shown in FIG. 23 with γ_{L}=0.7, μ_{L}=0.3, and σ_{L}=0.2. Notice the higher white Barycentric values are enhanced while there is very little loss in the low values. The relationship between input and output coordinates depends heavily on the γ_{L}, μ_{L}, and σ_{L}, parameter values.

While lightness enhancement affects only the white and black Barycentric coordinates, chroma enhancement affects all coordinates. As illustrated in FIG. 18, the process of mapping points from a large ICS gamut to a much smaller OCS gamut significantly reduces the chroma of the sample points. Although they remain in the same relative position within their respective tetrahedra, the lower chroma may not be pleasing to end users. At the same time, users expect neutral colors to appear neutral. The chroma enhancements seek to push non-neutral colors closer to the gamut boundary, while preserving the neutrality of neutral colors, keeping them close to the white/black tetrahedra edges.

The chroma enhancement acts on the Barycentric chroma, ac, and Barycentric neutral, α_{N}, coordinates. The enhanced Barycentric chroma coordinate,

$${α}_{C}^{′} ,$$

is calculated using Eq. 35, where f(x:μ_{C},σ_{C}) is given in Eq. 29 and γ_{C}, μ_{C}, and σ_{C} are the chroma enhancement parameters.

$${α}_{C}^{′} = f ( {α}_{C}^{γ c} : {μ}_{C} , {σ}_{C} ) \qquad 35$$

The enhanced Barycentric neutral coordinate is given in Eq. 36.

$${α}_{N}^{′} = 1 - {α}_{C}^{′} \qquad 36$$

The enhanced individual Barycentric coordinates are then calculated using Eqs. 37-40. The ratio

$${α}_{N}^{′} / {α}_{N}$$

in Eqs. 37 and 38 and the ratio

$${α}_{C}^{′} / {α}_{C}$$

in Eqs. 39 and 40 are used to renormalize the enhanced values and preserve the unit sum relationship between the four enhanced Barycentric coordinates.

$${α}_{W}^{″} = \frac{{α}_{W}^{′} {α}_{N}^{′}}{{α}_{N}} \qquad 37$$

$${α}_{K}^{″} = \frac{{α}_{K}^{′} {α}_{N}^{′}}{{α}_{N}} \qquad 38$$

$${α}_{C , 1}^{′} = \frac{{α}_{C ,} {α}_{C}^{′}}{{α}_{C}} \qquad 39$$

$${α}_{c , 2}^{′} = \frac{{α}_{C , 2} {α}_{C}^{′}}{{α}_{C}} \qquad 40$$

The final set of lightness- and chroma-enhanced Barycentric coordinates, α″ is given in Eq. 41.

$${α}^{″} = [ {α}_{W}^{″} , {α}_{K}^{″} , {α}_{C , 1}^{′} , {α}_{C , 2}^{′} ] \qquad 41$$

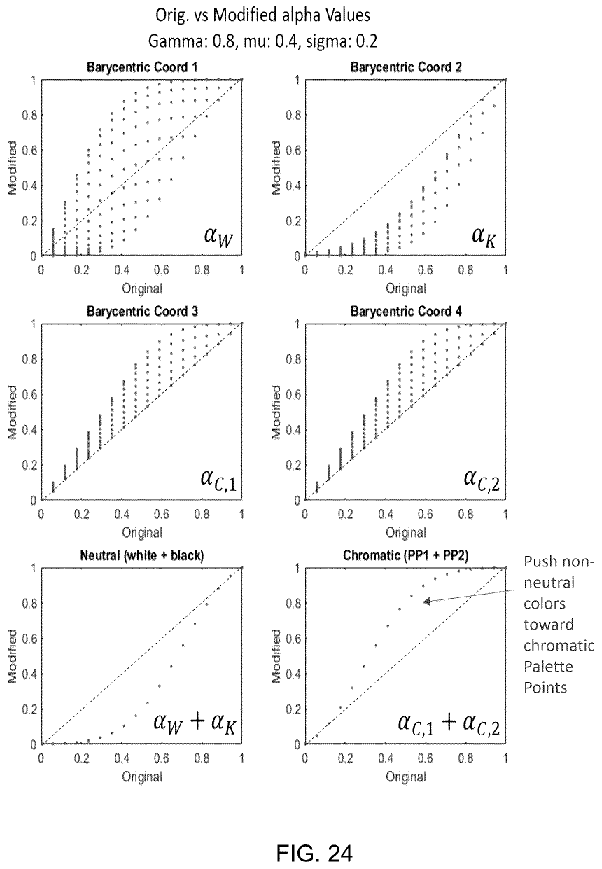

An example of Barycentric coordinates before and after chroma enhancement is shown in FIG. 24, with γ_{C}=0.8, μ_{C}=0.4, and σ_{C}=0.2. The top four plots are the four Barycentric coordinates, and the bottom two plots are α_{N} and α_{C}. Colors are pushed closer to the tetrahedra edges containing the chromatic points as α_{C} increases, as shown in the bottom right plot where

$${α}_{C}^{′} = {α}_{C}$$

when α_{C} is low and increases when α_{C} is high.

In one embodiment of the Barycentric enhancements, both the lightness and chroma enhancements, are used. In another embodiment, the lightness enhancement is used without the chroma enhancement, in which case the final set of enhanced Barycentric coordinates is given in Eq. 34. In a third embodiment, the chroma enhancement is used without the lightness enhancements, in which case α_{W} and α_{K} are used in place of

$${α}_{W}^{′} and {α}_{K}^{′}$$

### in Eqs. 37 and 38.

### Example Image Renderings

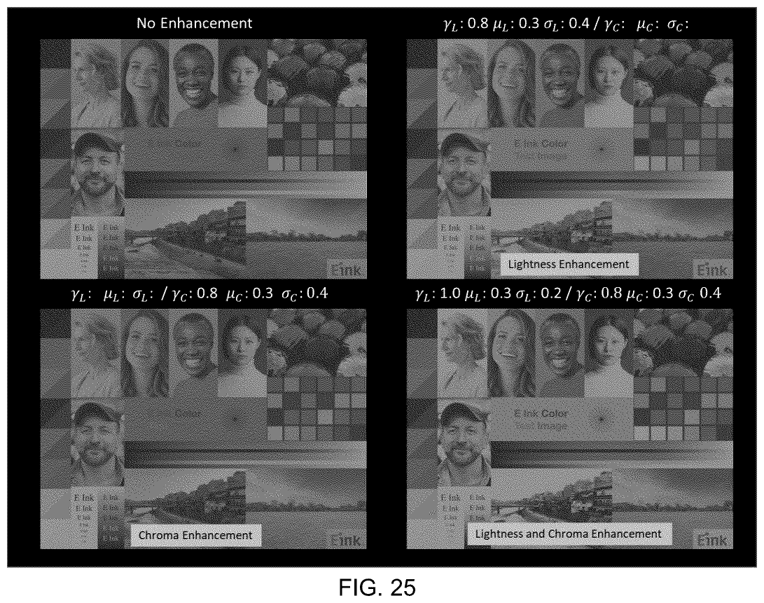

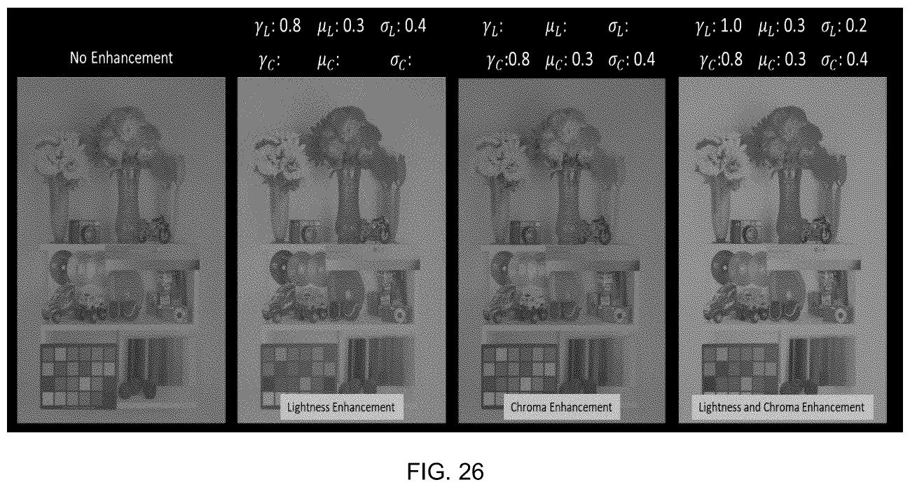

Images rendered using different combinations of γ_{L}, μ_{L}, σ_{L}, γ_{C}, μ_{C}, and σ_{C}, illustrate the effect of the lightness enhancement, chroma enhancement, and the combination of the two on rendered images. FIGS. 25 and 26 show renderings of two test images. The upper left image in FIG. 25 and the left image in FIG. 26 were rendered with no enhancements, lacking colors and having comparatively muted colors. The upper right image in FIG. 25 and second image in FIG. 26 were rendered using only the lightness enhancement with γ_{L}=0.8, μ_{L}=0.3, and σ_{L}=0.4. The images appear much brighter than the images with no enhancement, but the colors are still somewhat muted. The lower left image in FIG. 25 and third image in FIG. 26 were rendered using only the chroma enhancement with γ_{C}=0.8, μ_{C}=0.3, and σ_{C}=0.4. The renderings are darker than those with the lightness enhancement, but the colors appear more colorful. Finally, the lower right image in FIG. 25 and fourth image in FIG. 26 were rendered using both lightness and chroma enhancements with γ_{L}=1.0, μ_{L}=0.3, σ_{L}=0.2, γ_{C}=0.8, μ_{C}=0.3, and σ_{C}=0.4. The images appear both brighter and more colorful than the images with no enhancement. Both sets of images were mapped to the same OCS, but the lightness and chroma enhancements are able to produce more pleasing images.

The processes for building a CLUT described above may be implemented in software, hardware, firmware, or any combination thereof. The processes are preferably implemented in one or more computer programs executing on a programmable computer system including a processor, a storage medium readable by the processor (including, e.g., volatile and non-volatile memory and/or storage elements), and input and output devices. Each computer program can be a set of instructions (program code) in a code module resident in the random-access memory of the computer system. Until required by the computer system, the set of instructions may be stored in another computer memory (e.g., in a hard disk drive, or in a removable memory such as an optical disk, external hard drive, memory card, or flash drive) or stored on another computer system and downloaded via the Internet or other network. In one or more embodiments, the processes are implemented in a remote computer system to generate the CLUT, which is then transferred to the display device (e.g., stored in memory 70 of the display device 100 shown in FIG. 3B). The remote computer system may comprise one or more physical machines, or virtual machines running on one or more physical machines. In addition, the remote computer system may comprise a cluster of computers or numerous distributed computers that are connected by a network or the Internet. In one or more alternate embodiments, the processes are performed by a processor on the display device (e.g., processor 50 of FIG. 3B).

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A computer-implemented method, comprising:
(a) dividing a three-dimensional red-green-blue (RGB) input color space defined by a plurality of primary palette points, including a black primary palette point, a white primary palette point, and other primary palette points, into a plurality of adjacent, non-overlapping tetrahedra, each tetrahedron of the plurality of tetrahedra defined by the black primary palette point, the white primary palette point, and two of the other primary palette points;
(b) mapping sampled colors of the RGB input color space to grid points in an N× N×N grid;
(c) for each of the grid points, identifying a tetrahedron of the plurality of tetrahedra in which the grid point is located and calculating Barycentric coordinates of the grid point in the tetrahedron;
(d) performing lightness enhancement and/or chroma enhancement of the colors of the RGB input color space mapped to the grid points thereby modifying the Barycentric coordinates of the grid points for each color;
(e) calculating Cartesian coordinates of points in an RGB output color space defined by a plurality of output primary palette points for each of the colors enhanced in step (d) and mapped to the grid points having modified Barycentric coordinates; and
(f) populating a color lookup table (CLUT) with the grid points of the RGB input color space and corresponding Cartesian coordinates of the RGB output color space to be utilized for converting source images from the RGB input color space to the RGB output color space.

2. The method of claim 1, wherein the source images comprise RGB image files.

3. The method of claim 1, wherein the RGB output color space comprises a color gamut of a color electrophoretic display.

4. The method of claim 1, wherein the RGB input color space is divided into a plurality of adjacent, non-overlapping tetrahedra using Kuhn decomposition.

5. The method of claim 1, wherein the plurality of primary palette points comprises the black primary palette point, the white primary palette point, a red primary palette point, a green primary palette point, a blue, primary palette point, a cyan primary palette point, a magenta primary palette point, and a yellow primary palette point.

6. The method of claim 1, wherein the RGB input color space comprises a cube having eight vertices, each corresponding to a different one of the plurality of primary palette points, and the RGB output color space comprises an asymmetric polyhedron having eight vertices, each corresponding to a different one of the plurality of output primary palette points.

7. The method of claim 1, wherein lightness enhancement is performed by reapportioning the Barycentric coordinates for white and black colors.

8. The method of claim 1, wherein chroma enhancement is performed by moving the Barycentric coordinates for colors other than black and white colors toward a gamut boundary, while preserving neutrality of neutral colors.

9. The method of claim 1, further comprising converting a source image from the RGB input color space to the RGB output color space using the CLUT, and displaying the image in the RGB output color space on an electrophoretic display.

10. A color display, comprising:
an electrophoretic display comprising a light-transmissive electrode, an active matrix of pixel electrodes, and an electrophoretic medium comprising multiple types of electrophoretic particles having different optical properties, the electrophoretic medium being disposed between the light-transmissive electrode and the active matrix of pixel electrodes, the electrophoretic display being capable of producing a plurality of primary colors at each pixel electrode;
at least one processor;
at least one controller coupled to the at least one processor, and configured to provide electrophoretic display pixel color instructions to the active matrix of pixel electrodes; and
at least one non-transitory memory coupled to the at least one processor having the CLUT generated by the method of claim 1 stored therein and a program stored therein containing a plurality of instructions which, when executed by the at least one processor, cause the at least one processor to (i) convert a source image from the RGB input color space to the RGB output color space using the CLUT, and (ii) instruct the at least one controller to cause the electrophoretic medium to display the image in the RGB output color space.

11. A computer-implemented method, comprising:
(a) converting coordinates of primary palette points defining a three-dimensional device-dependent red-green-blue (RGB) input color space to coordinates of a three-dimensional device-independent color space, wherein the primary palette points comprise a black primary palette point, a white primary palette point, and other primary palette points;
(b) dividing the three-dimensional RGB input color space defined by the primary palette points having coordinates converted in step (a) into a plurality of adjacent, non-overlapping tetrahedra, each tetrahedron of the plurality of tetrahedra defined by the black primary palette point, the white primary palette point, and two of the other primary palette points;
(c) mapping sampled colors of the three-dimensional device-dependent RGB input color space to grid points in an N×N×N grid;
(d) converting the grid points of the RGB input color space to corresponding values of the device-independent color space;
(e) for each of the RGB input color space grid points converted in step (d), identifying a tetrahedron of the plurality of tetrahedra in which the grid point is located and calculating Barycentric coordinates of the grid point in the tetrahedron;
(f) performing lightness enhancement and/or chroma enhancement of colors mapped to the grid points thereby modifying the Barycentric coordinates of the grid points for each color;
(g) calculating Cartesian coordinates of points in an RGB device-independent output color space defined by a plurality of device-independent output primary palette points for each of the colors enhanced in step (f) and mapped to the grid points having modified Barycentric coordinates;
(h) converting the points of the RGB device-independent output color space calculated in step (g) to the RGB input color space; and
(i) populating a color lookup table (CLUT) with the grid points of the RGB input color space and corresponding Cartesian coordinates of the RGB output color space to be utilized for converting source images from the RGB input color space to the RGB output color space.

12. The method of claim 11, wherein the device-independent color space comprises a CIE XYZ color space, a CIE L*a*b* color space, or an IPT color space.

13. The method of claim 11, wherein the source images comprise RGB image files or standard RGB (SRGB) image files.

14. The method of claim 11, wherein the RGB output color space comprises a color gamut of a color electrophoretic device, and wherein the RGB input color space is divided into a plurality of adjacent, non-overlapping tetrahedra using Kuhn decomposition.

15. The method of claim 11, wherein lightness enhancement is performed by reapportioning the Barycentric coordinates for white and black colors, and wherein chroma enhancement is performed by moving the Barycentric coordinates for colors other than black and white colors toward a gamut boundary, while preserving the neutrality of neutral colors.

16. A color display, comprising:
an electrophoretic display comprising a light-transmissive electrode, an active matrix of pixel electrodes, and an electrophoretic medium comprising multiple types of electrophoretic particles having different optical properties, the electrophoretic medium being disposed between the light-transmissive electrode and the active matrix of pixel electrodes, the electrophoretic display being capable of producing a plurality of primary colors at each pixel electrode;
at least one processor;
at least one controller coupled to the at least one processor, and configured to provide electrophoretic display pixel color instructions to the active matrix of pixel electrodes; and
at least one non-transitory memory coupled to the at least one processor having the CLUT generated by the method of claim 11 stored therein and a program stored therein containing a plurality of instructions which, when executed by the at least one processor, cause the at least one processor to (i) convert a source image from the RGB input color space to the RGB output color space using the CLUT, and (ii) instruct the at least one controller to cause the electrophoretic medium to display the image in the RGB output color space.

17. A computer-implemented method, comprising:
(a) dividing a three-dimensional red-green-blue (RGB) input color space defined by a plurality of primary palette points, including a black primary palette point, a white primary palette point, and other primary palette points, into a plurality of adjacent, non-overlapping tetrahedra, each tetrahedron of the plurality of tetrahedra defined by the black primary palette point, the white primary palette point, and two of the other primary palette points;
(b) mapping sampled colors of the RGB input color space to grid points in an N× N×N grid;
(c) performing at least one of brightness enhancement, contrast enhancement, and saturation enhancement of the colors of the RGB input color space mapped to the grid points;
(d) for each of the grid points, identifying a tetrahedron of the plurality of tetrahedra in which the grid point is located and calculating Barycentric coordinates of the grid point in the tetrahedron;
(e) calculating Cartesian coordinates of points in an RGB output color space defined by a plurality of output primary palette points for each of the colors enhanced in step (c) and mapped to the grid points having the Barycentric coordinates; and
(f) populating a color lookup table (CLUT) with the grid points of the RGB input color space and corresponding Cartesian coordinates of the RGB output color space to be utilized for converting source images in the RGB input color space to the RGB output color space.

18. The method of claim 17, wherein the RGB output color space comprises a color gamut of a color electrophoretic display, and wherein the RGB input color space is divided into a plurality of adjacent, non-overlapping tetrahedra using Kuhn decomposition, and wherein the RGB input color space comprises a cube having eight vertices, each corresponding to a different one of the plurality of primary palette points, and the RGB output color space comprises an asymmetric polyhedron having eight vertices, each corresponding to a different one of the plurality of output primary palette points.

19. The method of claim 17, further comprising converting a source image from the RGB input color space to the RGB output color space using the CLUT, and displaying the image in the RGB output color space on an electrophoretic display.

20. A color display, comprising:
an electrophoretic display comprising a light-transmissive electrode, an active matrix of pixel electrodes, and an electrophoretic medium comprising multiple types of electrophoretic particles having different optical properties, the electrophoretic medium being disposed between the light-transmissive electrode and the active matrix of pixel electrodes, the electrophoretic display being capable of producing a plurality of primary colors at each pixel electrode;
at least one processor;
at least one controller coupled to the at least one processor, and configured to provide electrophoretic display pixel color instructions to the active matrix of pixel electrodes; and
at least one non-transitory memory coupled to the at least one processor having the CLUT generated by the method of claim 17 stored therein and a program stored therein containing a plurality of instructions which, when executed by the at least one processor, cause the at least one processor to (i) convert a source image from the RGB input color space to the RGB output color space using the CLUT, and (ii) instruct the at least one controller to cause the electrophoretic medium to display the image in the RGB output color space.
